(19) United States
(12) Patent Application Publication
(10) Pub. No.: US 2008/0100828 A1
(43) Pub. Date: May 1, 2008

(54) Polarization-sensitive optical time domain reflectometer and method for determining PMD

(76) Inventors: Normand Cyr, Quebec (CA); Hongxin Chen, Quebec (CA)

Correspondence Address: ADAMS PATENT & TRADEMARK AGENCY, P.O. BOX 11100, STATION H, OTTAWA, ON, K2H 7T8, US

(21) Appl. No.: 11/727,759

(22) Filed: Mar. 28, 2007

Related U.S. Application Data
(63) Continuation-in-part of application No. PCT/CA06/01610, filed on Sep. 29, 2006.
(60) Provisional application No. 60/721,532, filed on Sep. 29, 2005.
(60) Provisional application No. 60/831,448, filed on Jul. 18, 2006.

(51) Int. Cl. G01N 21/00

(52) U.S. Cl. 356/73.1

(57) ABSTRACT

In a method of measuring cumulative polarization mode dispersion (PMD) along the length of a fiber-under-test (FUT), a polarization-sensitive optical time domain reflectometer (POTDR) is used to inject into the FUT plural series of light pulses arranged in several groups. Each group comprises at least two series of light pulses having different but closely-spaced wavelengths and the same state of polarization (SOP). At least two, and preferably a large number of such groups, are injected and corresponding OTDR traces obtained for each series of light pulses by averaging the impulse-response signals of the several series of light pulses in the group. The process is repeated for a large number of groups having different wavelengths and/or SOPs. The PMD then is obtained from the resulting normalized OTDR traces of all of the groups, by computing the difference between each normalized OTDR trace in one group and the corresponding normalized OTDR trace in another group, followed by the mean-square value of the differences. Finally, the PMD is computed as a predetermined function of the mean-square difference. The function may, for example, be a differential formula, an arcsine formula, and so on.

### CROSS-REFERENCE TO RELATED DOCUMENTS

This is a Continuation-in-Part of International patent application number PCT/CA2006/001610 filed Sep. 29, 2006 claiming priority from U.S. Provisional patent application No. 60/721,532 filed Sep. 29, 2005, the entire contents of both of which applications are incorporated herein by reference. This application also claims priority from U.S. Provisional patent application Ser. No. 60/831,448 filed Jul. 18, 2006, the contents of which are incorporated herein by reference.

The present application is related to Disclosure Document No. 564,640 entitled “Robust Accumulated Polarization Mode Dispersion Measurements by Use of a Single End OTDR Technique, filed in the United States Patent and Trademark Office on Nov. 9, 2004. The entire contents of this Disclosure Document are incorporated herein by reference.

### TECHNICAL FIELD

The invention relates to a method and apparatus for measuring polarization-dependent characteristics of optical paths and is especially applicable to so-called polarization-sensitive optical time domain reflectometers, and corresponding methods, for measuring polarization mode dispersion (PMD) of an optical path which comprises mostly optical waveguide, such as an optical fiber link.

### BACKGROUND ART

In optical fibers used in optical communications systems, orthogonal polarization modes have different group delays; known as differential group delay (DGD). This causes the polarization mode dispersion (PMD) phenomenon, i.e., a spreading of the pulses propagating along the fibers. Where long optical fiber links are involved, overall PMD may be sufficient to cause increased bit error rate, thus limiting the transmission rate or maximum transmission path length. This is particularly problematical at higher bit rates. As a variable or quantity characterizing the said phenomenon, the PMD value of a device is defined as either the mean value or the root-mean-square (RMS) value of DGD (the DGD of a given device is a random variable that varies over both wavelength and time).

As explained in commonly-owned U.S. Pat. No. 6,724,469 (Leblanc), in optical communication systems, an unacceptable overall polarization mode dispersion (PMD) level for a particular long optical fiber may be caused by one or more short sections of the overall optical fiber link. Where, for example, a network service provider wishes to increase the bitrate carried by an installed optical fiber link, say up to 40 Gb/s, it is important to be able to obtain a distributed measurement of PMD, i.e., obtain the PMD information against distance along the fiber, and locate the singularly bad fiber section(s) so that it/they can be replaced—rather than replace the whole cable.

It is known to use a so-called polarization-sensitive optical time domain reflectometer (POTDR; also commonly referred to as a “Polarization optical time domain reflectometer”) to try to locate such sections. Basically, a POTDR is an optical time domain reflectometer (OTDR) that is sensitive to the state of polarization (SOP) of the backreflected signal.

Whereas conventional OTDRs measure only the intensity of backreflected light to determine variation of attenuation along the length of a transmission path, e.g., an installed optical fiber, POTDRs utilize the fact that the backreflected light also exhibits polarization dependency to monitor polarization dependent characteristics of the transmission path. Thus, the simplest POTDR comprises an OTDR having a polarizer between its output and the fiber-under-test (FUT) and an analyzer in the return path, between its photodetector and the FUT. (It should be appreciated that, although a typical optical transmission path will comprise mostly optical fiber, there will often be other components, such as couplers, connectors, etc., in the path. For convenience of description, however, such other components will be ignored, it being understood, however, that the term “FUT” used herein will embrace both an optical fiber and the overall transmission path according to context.)

Generally, such POTDRs can be grouped into two classes or types. Examples of the first type of POTDR are disclosed in the following documents:
F. Corsi, A. Galtarossa, L. Palmieri, “Beat Length Characterization Based on Backscattering Analysis in Randomly Perturbed Single-Mode Fibers,” Journal of Lightwave Technology, Vol. 17, No. 7, July 1999.
A. Galtarossa, L. Palmieri, A. Pizzinat, M. Schiano, T. Tambosso, “Measurement of Local Beat Length and Differential Group Delay in Installed Single-Mode Fibers”, “Journal of Lightwave Technology, Vol. 18, No. 10, October 2000. (N.B. only total PMD from end-to-end is measured for comparison, not cumulative PMD vs z.).
A. Galtarossa, L. Palmieri, M. Schiano, T. Tambosso, “Measurement of Beat Length and Perturbation Length in Long Single-Mode Fibers,” Optics Letters, Vol. 25, No. 6, Mar. 15, 2000.
B. Huttner, “Distributed PMD measurement with a polarization-OTDR in optical fibers”, Journal of Lightwave Technology, Vol. 17, pp. 1843-1948, March 1999.
U.S. Pat. No. 6,946,646 (Chen et al.)
US published patent application number 2004/0046955, Fayolle et al.

The first type of POTDR basically measures local birefringence (1/beat-length) as a function of distance z along the fiber, or, in other words, distributed birefringence. Referring to the simple and well-known example of a retardation waveplate, birefringence is the retardation (phase difference) per unit length between the “slow” and “fast” axes. In other words, the retardation is the birefringence times the thickness of the waveplate. This is not a PMD measurement, though that is a common misconception. First, in a simplified picture, DGD(z) is the derivative, as a function of optical frequency (wavelength), of the overall retardation of the fiber section extending from 0 to z. Second, a long fiber behaves as a concatenation of a large number of elementary “waveplates” for which the orientation of the fast and slow axes, as well as the retardation per unit length, vary randomly as a function of distance z.

Accordingly, DGD(z) is the result of a complicated integral over all that lies upstream that exhibits random birefringence and random orientation of the birefringence axis as a function of z, whereas birefringence is the retardation per unit length at some given location. Additionally, as mentioned above, the derivative, as a function of optical frequency, of such integral must be applied in order to obtain DGD as per its definition. A general limitation of all the techniques of this first type, therefore, is that they do not provide a direct, reliable, valid in all cases and quantitative measurement of PMD with respect to distance along the optical fiber. Instead, they measure local birefringence (or beat-length) and/or one or more related parameters and infer the PMD from them based notably on assumptions about the fiber characteristics and specific models of the birefringence. For instance, they generally assume a relationship between PMD and local values of the birefringence and so-called coupling-length (or perturbation-length), which does not necessarily stand locally even when it stands on average.

As an example, such techniques assume that fibers exhibit exclusively “linear” birefringence. If circular birefringence is indeed present, it is “missed” or not seen, because of the properties of a round trip through the fiber (OTDR technique). Notably, twisted fibers like modern spun fibers already require some special models, which implies that an instrument must know in advance the type and characteristics of the FUT, which is unacceptable for a commercial instrument.

As a second example, the birefringence and other parameters must be measured accurately throughout the length, even in sections where the local characteristics of the fiber do not satisfy the assumed models and conditions; otherwise, the inferred PMD of such sections, which is an integral over some long length, can be largely misestimated, even qualitatively speaking. In practice, although they can measure birefringence quantitatively (cf. F. Corsa et al. supra), or statistically screen high birefringence sections (Chen et al. supra), or obtain qualitative and relative estimates of the PMD of short sections provided that one accept frequently occurring exceptions (Leblanc, Huttner, supra), POTDR techniques of this first type cannot reliably and quantitatively measure PMD, particularly of unknown, mixed installed fibers in the field. Furthermore, they are incapable of inferring, even approximately, the overall PMD of a long length of fiber, such as for example 10 kilometers.

Fayolle et al. (supra) claim to disclose a technique that is “genuinely quantitative, at least over a given range of polarization mode dispersion”. However, this technique also suffers from the fundamental limitations associated with this type, as mentioned above. In fact, while their use of two SOPs (45° apart) with two trace variances might yield a modest improvement over the similar POTDRs of the first type (e.g., Chen et al.'s, whose VOS is essentially the same as Fayolle et al.'s trace variance), perhaps by a factor of \sqrt{2}, it will not lead to a truly quantitative measurement of the PMD with respect to distance along the FUT with an acceptable degree of accuracy. It measures a parameter that is well-known to be related or correlated with beat-length (birefringence), but not representative of the PMD coefficient. Indeed, even the simulation results disclosed in Fayolle et al.'s specification indicate an uncertainty margin of 200 percent.

It is desirable to be able to obtain direct, quantitative measurements of PMD, i.e., to measure the actual cumulative PMD at discrete positions along the optical fiber, as if the fiber were terminated at each of a series of positions along its length and a classical end-to-end PMD measurement made. This is desirable because the parameter that determines pulse-spreading is PMD, not birefringence. If one knows the actual PMD value of a communications link one can determine, accurately, the bit error rate or outage probability (probability that the communication will fail over a period of time), or the power penalty (how much more power must be launched to maintain the same bit error rate as if there were no PMD).

(In this specification, the term “cumulative PMD” is used to distinguish from the overall PMD that is traditionally measured from end-to-end. Because PMD is not a localized quantity, PMD(z) is an integral from 0 to z, bearing resemblance to a cumulative probability rather than the probability distribution. When distance z is equal to the overall length of the FUT, of course, the cumulative PMD is equal to the overall PMD.)

The second type of known POTDR is dedicated specifically to PMD measurement. This type does not suffer from the above-mentioned fundamental limitations of the first type of POTDR and so represents a significant improvement over them, at least in terms of PMD measurement. It uses the relationship between POTDR traces obtained at two or more closely-spaced wavelengths in order to measure PMD directly at a particular distance z, i.e., cumulative PMD, with no need for any assumption about the birefringence characteristics of the fibers, no need for an explicit or implicit integral over length, no missed sections, no problem with spun fibers, and so on. Even a circularly birefringent fiber or a section of polarization-maintaining fiber (PMF) is measured correctly. In contrast to implementations of the first type, there is no need to invoke assumptions and complicated models in order to qualitatively infer PMD.

Thus, measurement of cumulative PMD as a function of distance z along the fiber, and its corresponding slope, as allowed by a POTDR of this second type, facilitates reliable identification and quantitative characterization of those singular, relatively-short sections where the slope of the PMD vs. distance is large over some distance, thus accounting for almost all the PMD of the link, the rest contributing a much smaller percentage of the total PMD.

Most known POTDR techniques of this second type rely upon there being a deterministic relationship between the OTDR traces obtained with a small number of specific input-SOP and output polarization axes, as disclosed, for example, in U.S. Pat. No. 6,229,599 (Galtarossa), an article by H. Sunnerud, B-E. Olsson, P. A. Andrekson, “Measurement of Polarization Mode Dispersion Accumulation along Installed Optical Fibers”, IEEE Photonics Technology Letters, Vol. 1, No. 7, July 1999 and an article by H. Sunnerud, B-E. Olsson, M. Karlsson, P. A. Andrekson and J. Bretnel entitled “Polarization-Mode Dispersion Measurements Along Installed Optical Fibers Using Gated Backscattered Light and a Polarimeter”, Journal of Lightwave Technology, Vol. 18, No. 7, July 2000. This requires the FUT to be spatially stable throughout the time period over which all the traces are measured. Unfortunately, such stability cannot be assured, especially where an installed fiber is being measured.

In addition, known techniques of the second type require the use of short pulses; “short” meaning shorter than the beat length and coupling length of any section of the FUT. In order for them to measure high PMD in fibers properly, without being limited to fibers of very long beat length (which often will have low PMD), they must use OTDR optical pulse widths of less than 5 to 10 ns at maximum. Unfortunately, practical OTDRs do not have a useful dynamic range with such short pulses. On the other hand, if a long light pulse is used, only fibers having long beat lengths can be measured, which limits these techniques, overall, to measurement of short distances and/or with long measurement times, or to fibers with large beat length (typically small PMD coefficient). Hence, although it might be possible, using known techniques and meeting the above-mentioned requirements, to make a reasonably successful measurement, at present their scope of application and performance would be insufficient for commercially-viable, stand-alone instrument.

In addition, the use of short pulses exacerbates signal-to-noise ratio (SNR) problems due to the so-called coherence noise that superimposes on OTDR traces and is large when short pulses are used. It is due to the fact that the power of the backreflected light is not exactly the sum of powers emanating from each element (dz) of the fiber. With a coherent source such as a narrowband laser, as used in POTDR applications, there is interference between the different backscattering sources. This interference or coherence noise that is superimposed on the ideal trace (sum of powers) is inversely proportional to both the pulse width (or duration) and the laser linewidth. It can be decreased by increasing the equivalent laser linewidth, i.e., the intrinsic laser linewidth as such, or, possibly, by using “dithering” or averaging traces over wavelength, but this reduces the maximum measurable PMD and hence may also limit the maximum length that can be measured, since PMD increases with increasing length. Roughly speaking, the condition is PMD·Linewidth<1 (where the linewidth is in optical frequency units); otherwise the useful POTDR signal is “washed out” by depolarization.

Accordingly, known POTDR techniques suffer from the limitation that they do not measure, quantitatively and accurately, cumulative PMD at specific distances along a FUT, especially a long optical fiber of the kind now being used in optical communications systems, with a satisfactory dynamic range (long pulses) and without stringent requirements regarding the stability of the FUT.

### SUMMARY OF THE INVENTION

The present invention seeks to eliminate, or at least mitigate, the disadvantages of the prior art discussed above, or at least provide an alternative.

According to a first aspect of the invention, there is provided a method of measuring cumulative polarization mode dispersion (PMD) along the length of a fiber-under-test (FUT) comprising the steps of:

launching into the FUT at least two groups of series of light pulses, each group comprising at least one pair of series of light pulses, a wavelength of light pulses in one of the series in the pair being closely-spaced from a wavelength of the light pulses in the other series in said at least one pair, said series of light pulses in each group having input-output polarization states and/or center wavelengths that are uncorrelated with respect to those of the series of light pulses in the at least one other group,

measuring, point-by-point temporally and for each of said at least two groups, differences between respective optical powers of at least one polarization component of light backreflected for at least some of the pairs of series of light pulses,

computing the cumulative PMD as a function of distance z along the FUT as a predetermined function of the measured optical power differences, and

outputting at least a subset of the computed cumulative PMD value, for example as a signal to control a display device or in some other concrete and tangible form.

outputting at least a subset of the computed cumulative PMD value, for example as a signal to control a display device or in some other concrete and tangible form.

Throughout this specification, the term “backreflected” encompasses any reflected light which propagates along the FUT in the opposite direction to the initially launched light pulses and may comprise Rayleigh backscattering and discrete “Fresnel” reflections. The term “input-output state of polarization (I/O-SOP)” represents one setting of a polarization controller that sets both a given state of polarization of the launched light pulses and a correlated state of polarization of the corresponding polarization component that is detected.

The term “center wavelength” of a group, as used herein, generally refers to the average of the wavelengths of the different series of light pulses comprising the group. The center wavelength of each pair of series of light pulses is defined as the average of the actual wavelengths of the series of light pulses. Where the group comprises more than one pair of series of light pulses, the center wavelength as defined above in fact differs for each pair in the group. It should be noted that the center wavelength is only a conceptual definition, used primarily for the purpose of facilitating description of a specific embodiment having one pair of wavelengths. The meaning of “closely-spaced wavelengths” will be explained more fully hereinafter.

Thus, the light pulses in the pair of series of light pulses in a group have the same I/O-SOP, but light pulses in the different series in a particular group have different but closely-spaced wavelengths. The light pulses in each group have either or both of a different I/O-SOP and different center wavelength as compared with those of the or each other group.

Preferably, the step of computing the cumulative PMD comprises the steps of:

for each group, computing a pair of normalized OTDR traces corresponding to the pair of series of light pulses, respectively, in that group, point-by-point temporally,

for each temporal point, computing the difference between the normalized OTDR traces in each said pair of normalized OTDR traces;

for each temporal point, computing a mean-square value of the differences corresponding to the pairs of series that are in the different groups but have the same close wavelength spacing;

converting the resulting mean square values to equivalent mean square values with respect to distance z along the FUT,

the cumulative PMD as a function of distance z then being computed as a predetermined function of said equivalent mean square values.

In preferred embodiments, each group comprises at least one additional series of light pulses having a different wavelength closely-spaced from the first and second wavelengths for that group, the spacings between respective pairs of the three wavelengths being different, OTDR traces are acquired for the at least one additional series of light pulses, and the said differences between normalized OTDR traces are computed also for at least a second pair of said OTDR traces in each group, the resulting additional differences being used to compute a mean-square value of the differences computed for the pairs of additional series that are in the different groups but have the same close wavelength spacing, the resulting additional mean square values being converted to equivalent mean square values with respect to distance along the FUT; a corresponding additional cumulative PMD value at any distance z being computed therefrom, and at least a subset of the additional cumulative PMD being outputted.

Both the first-mentioned cumulative PMD values as a function of distance z and the additional cumulative PMD value as a function of z may be stored and/or displayed to permit a user to access either or both.

The outputted cumulative PMD value as a function of z then may comprise a subset of values calculated from the first-mentioned cumulative PMD value and a subset from the additional cumulative PMD value, which of the at least two subsets outputted for a given z value being determined according to which close wavelength spacing is the best suited given the knowledge of both the first-mentioned PMD value and additional PMD value at each point z.

Each group may comprise an additional pair of at least two series of light pulses each having the same wavelength as a respective one of the series in the first pair, the differences between optical power of at least one polarization component of light backreflected for at least two groups of the additional pair of series of light pulses being measured in a similar manner to that for the corresponding first-mentioned pair of series of light pulses, the computation of said mean square value for each temporal point taking into account the additional optical power differences.

The computing step may comprise the steps of computing the relative variance of the normalized traces, point by point temporally, and averaging said relative variances to obtain the overall variance of all of the traces in the at least two groups for each temporal point, and computing the ratio of the mean-square difference over the relative variance, said cumulative PMD at any distance z being computed as a function of said ratio. These additional steps are necessary when the POTDR is operated with pulses having a spatial extent much greater than about one-tenth of the minimum beat length in the FUT.

In preferred embodiments, the process is repeated for a large number of groups of pairs of series of light pulses, each group having a different center wavelength and/or I/O-SOP as compared with the other groups.

One polarization component of the backreflected light may be detected, conveniently using one detector, and the step of computing the cumulative PMD value from the optical power differences then may include the step of obtaining a normalized OTDR trace for each series of light pulses of a pair by dividing the OTDR trace representing optical power of the backreflected light for that series by the average of at least some, and preferably all, of the corresponding OTDR traces of the series in the different groups.

Alternatively, two orthogonal polarization components of the backreflected light may be detected for each series of light pulses and a normalized OTDR trace for that series of light pulses obtained by dividing at least one of the OTDR traces corresponding to the two detected different polarization components for that series by the sum of the OTDR traces corresponding to the two detected different polarization components for that series.

Alternatively, two orthogonal polarization components of the backreflected light may be detected for each series of light pulses and a normalized OTDR trace for that series of light pulses obtained by dividing a weighted difference of the OTDR traces corresponding to the two detected different polarization components for that series by the sum of the OTDR traces corresponding to the two detected different polarization components for that series.

Such two orthogonal polarization components may be detected simultaneously, conveniently using two photodetector. Alternatively, they may be detected sequentially, using the same detector.

One polarization component and the total optical power may be detected, conveniently using two detectors, and the normalized OTDR trace corresponding to that particular series of light pulses obtained by dividing the OTDR trace for that series by the OTDR trace for that series corresponding to total power.

The resulting curve or graph of cumulative PMD as a function of distance z in concrete and tangible form may be displayed on a suitable display device, Preferably, OTDR traces are obtained in a similar manner for a large number of groups having different I/O-SOPs and/or center-wavelengths, preferably with both different I/O-SOPs and center-wavelengths. Advantageously, at least ten different I/O-SOPs and/or center wavelengths are used to provide meaningful results, e.g. for a fast estimate having limited accuracy. For high accuracy regardless of how small the PMD value may be and for reliable results with any type of FUT including PMF fibers or normal fibers having a low polarization coupling ratio, however, it is preferable to repeat the process as many as 100-200 times with both different I/O-SOPs and different center wavelengths.

According to a second aspect of the invention, there is provided apparatus for measuring cumulative polarization mode dispersion (PMD) along the length of a fiber-under-test (FUT) comprising:

means for launching into the FUT at least two groups of series of light pulses, each group comprising at least one pair of series of light pulses, a wavelength of light pulses in one of the series in the pair being closely-spaced from a wavelength of the light pulses in the other series in said at least one pair, said series of light pulses in each group having input-output polarization states and/or center wavelengths that can be uncorrelated with respect to those of the series of light pulses in the at least one other group,

means for detecting backreflected light from the FUT and measuring, point-by-point temporally and for each of said at least two groups, differences between respective optical powers of at least one polarization component of light backreflected for at least some of the pairs of series of light pulses,

means for computing the cumulative PMD as a function of distance z along the FUT as a predetermined function of the measured optical power differences, and

means for outputting at least a subset of the computed cumulative PMD value, for example as a signal to control a display device or in some other concrete and tangible form.

In preferred embodiments of the second aspect of the invention, the apparatus comprises:

(i) means for injecting into an end of a fiber-under-test (FUT 16) groups of series of light pulses at selected wavelengths and selected input-output states of polarization (I/O-SOPs),
(ii) detection means for detecting, for each of at least some of the light pulses in each series of light pulses, at least one polarization component of the resulting backreflected signal and determining total backreflected power (S₀) of the resulting backreflected signal to provide a corresponding impulse response,
(iii) control means for controlling the injecting means and the detecting, sampling and averaging means to cause:

(a) said injecting means to inject into one end of the FUT a first group of at least a pair of series of light pulses, the light pulses in one series of the pair having a wavelength (λ_{L}⁽⁰⁾) that is closely-spaced from the wavelength (λ_{U}⁽⁰⁾) of light pulses in the other series of said pair, the at least one pair of series of light pulses in said group having the same input-output state of polarization (I/O-SOP₀);

(b) the detecting, sampling and averaging means to detect, for each of at least some of the light pulses in each series of light pulses, at least one polarization component of the resulting backreflected light to provide a corresponding impulse response, said at least one polarization component being the same for each of the light pulses whose polarization component has been detected, and convert each of the impulse responses into a corresponding electrical impulse-response signal to provide a corresponding first group of electrical impulse-response signals, and to sample and average each series of said electrical impulse-response signals to provide a first group of OTDR traces each representing detected backreflected power versus time for a respective one of the series of light pulses of said first group;

(d) said injecting means to inject into said one end of the FUT at least a second group of at least a pair of series of light pulses having either or both of a different input-output state of polarization (I/O-SOP₁) and a different center wavelength (λ₁) as compared with center wavelength (λ₀) of the first group of series of light pulses,

(e) the detecting, sampling and averaging means to detect, for each of at least some of the light pulses in each series of light pulses, at least one polarization component of the resulting backreflected light to provide a corresponding impulse response, said at least one polarization component being the same for each of the light pulses whose polarization component has been detected, and convert each of the impulse responses into a corresponding electrical impulse-response signal to provide a corresponding second group of electrical impulse-response signals, and to sample and average each series of said second group of electrical impulse-response signals to provide a second group of OTDR traces each representing detected backreflected power versus time for a respective one of the series of light pulses of said second group;

(iv) computing means (32) for computing, for each group:
(a) a normalized OTDR trace for each of said OTDR traces;
(b) the difference, point-by-point temporally, between the or each pair of normalized OTDR traces corresponding to said at least one pair of series of light pulses; and
(c) the mean-square value of said differences for each temporal point to obtain a mean square value as a function of time and, using a known effective refractive index of the fiber at or near the measurement wavelengths, the said mean square difference as a function of distance (z) along the FUT;

(c) the PMD value as a predetermined function of said mean-square value as a function of distance, said predetermined function being cast as, for example, a differential formula, an arcsine formula, and so on; and

(vii) outputting the cumulative PMD value as a function of distance z, for example by displaying the graph of cumulative PMD as a function of distance z on a display device.

The detecting means may detect one polarization component and the computing means obtain a normalized OTDR trace for each series of light pulses of a pair by dividing the OTDR trace representing optical power of the backreflected light for that series by the average of at least some, and preferably all, of the corresponding OTDR traces of the series in the different groups.

Alternatively, the detecting means may detect two orthogonal polarization components of the backreflected light for each series of light pulses and the computing means compute a normalized OTDR trace for that series of light pulses by dividing at least one of the OTDR traces corresponding to the two detected different polarization components for that series by the sum of the OTDR traces corresponding to the two detected different polarization components for that series.

The detecting means may detect two orthogonal polarization components of the backreflected light for each series of light pulses and the computing means compute a normalized OTDR trace for that series of light pulses obtained by dividing a weighted difference of the OTDR traces corresponding to the two detected different polarization components for that series by the sum of the OTDR traces corresponding to the two detected different polarization components for that series.

The detecting means may detect one polarization component and the total optical power, and the computing means compute the normalized OTDR trace corresponding to that particular series of light pulses by dividing the OTDR trace for that series by the OTDR trace for that series corresponding to the detected total optical power.

The detecting means may comprise two photodetectors for detecting said two polarization components simultaneously.

Alternatively, the detecting means may use a single detector and switching means for enabling detection of said two polarization components sequentially.

In general, the computation of the normalized OTDR traces will differ according to the detection scheme used.

As in preferred embodiments of the method of the first aspect of the invention, the computing means may compute the relative variance of the normalized traces, point by point temporally, average said relative variances to obtain the overall variance of all of the traces in the at least two groups for each temporal point, compute the ratio of the mean-square difference over the relative variance, and compute said cumulative PMD at any distance z as a function of said ratio. These additional computational steps are necessary when the apparatus is operated with pulses having a spatial extent much greater than about one-tenth of the minimum beat length in the FUT.

In embodiments of either of the foregoing aspects of the invention, each of the first group of at least one pair of series of light pulses and second group of at least one pair of series of light pulses may include at least one additional series of light pulses having a wavelength (λ_{I}⁽⁰⁾; λ_{I}⁽¹⁾) closely-spaced from the closely-spaced wavelengths (λ_{L}⁽⁰⁾; λ_{L}⁽¹⁾) and (λ_{U}⁽⁰⁾; λ_{U}⁽¹⁾) of the first-mentioned pair of series of light pulses, all three series of light pulses in each said group having the same state of polarization (SOP₀; SOP₁), each of said different wavelengths (λ_{I}⁽⁰⁾; λ_{I}⁽¹⁾) being unequally spaced from the corresponding said closely-spaced wavelengths, respectively.

In preferred embodiments of either aspect of the invention, the points that represent the input-output-SOPs on the surface of the Poincaré sphere may be substantially uniformly-distributed over the surface of the sphere, or may form a regular grid of points that uniformly covers the said surface.

The light pulses may each extend over a relatively long length (length=duration times the speed of light in the fiber). For FUT lengths and attenuation characteristics typical of most telecommunications applications, each of the light pulses preferably has a duration that is equal to or longer than the minimum beat-length of the FUT, as this leads to an enhanced dynamic range in comparison with a POTDR using shorter pulses.

In embodiments of the second aspect of the invention, the means for injecting the series of light pulses may comprise a tunable pulsed light source for emitting light pulses and a polarization controller means, i.e., an I/O-SOP controller, for selecting both the SOP of the light pulses entering (i.e., “launched” into) the FUT and the SOP for analysis of the corresponding backreflected light received from the FUT, i.e. selecting said I/O-SOP.

The tunable pulsed light source means may comprise a tunable pulsed laser source and, for example, either a polarization-maintaining fiber or a polarization adjuster. The latter may be connected using fiber that is not polarization-maintaining.

The I/O-SOP controller may comprise polarization discriminator means and a SOP scrambler through which the light pulses pass in one direction and the backreflected light from the FUT passes in the opposite direction.

Where the detection means comprises two detectors for detecting a polarization component and total power of the backreflected light, the polarization discriminator may comprise a polarizer for extracting said polarization component, one detector being connected to the backreflection discriminator means, for example a circulator, and the other detector connected to a coupler between the backreflection discriminator means and the FUT, either interposed between the polarization discriminator means and the SOP scrambler, or following the SOP scrambler.

Alternatively, the I/O-SOP controller may comprise a polarization beam splitter (PBS) and a SOP scrambler. Where the detection means comprises two detectors, one may be connected to a circulator between the tunable pulsed light source and the I/O-SOP controller and the other to a second port of the PBS.

The output of the tunable pulsed light source means may be coupled to the input of the I/O SOP controller by a polarization-maintaining circulator and polarization-maintaining fiber.

The control means may change the I/O-SOP and wavelength of each series of light pulses concurrently.

The apparatus may use a tunable pulsed light source which can be tuned over a wide range of wavelengths, typically exceeding one hundred nanometers; but preferably encompassing the range used in most high-bitrate optical telecommunications systems. Such a widely-tunable arrangement facilitates the measurement of small PMD values.

The foregoing and other objects, features, aspects and advantages of the present invention will become more apparent from the following detailed description, in conjunction with the accompanying drawing, of preferred embodiments of the invention which are described by way of example only.

### BRIEF DESCRIPTION OF THE DRAWINGS

FIG. 1 is a simplified schematic diagram of a polarization-sensitive optical time domain reflectometer which is an embodiment of the present invention;

FIG. 2A is a schematic representation of an alternative tunable pulsed light source;

FIG. 2B is a schematic representation of a modification to an I/O-SOP controller of the POTDR;

FIG. 2C is a simplified schematic diagram of a polarization-sensitive optical time domain reflectometer which is a second embodiment of the present invention;

FIG. 3 is a polarization-sensitive optical time domain reflectometer which is a third embodiment of the present invention;

FIG. 4A is sections of a flowchart illustrating operation of the POTDR of FIG. 1;

FIG. 4B is a flowchart illustrating a trace acquisition step of the flowchart of FIG. 4A;

FIG. 5 is a schematic diagram illustrating another alternative tunable pulsed light source; and

FIG. 6 illustrates schematically another yet another alternative tunable pulsed light source.

### DESCRIPTION OF PREFERRED EMBODIMENTS

In the drawings, the same or similar components in the different Figures have the same reference numeral, where appropriate with a prime indicating a difference.

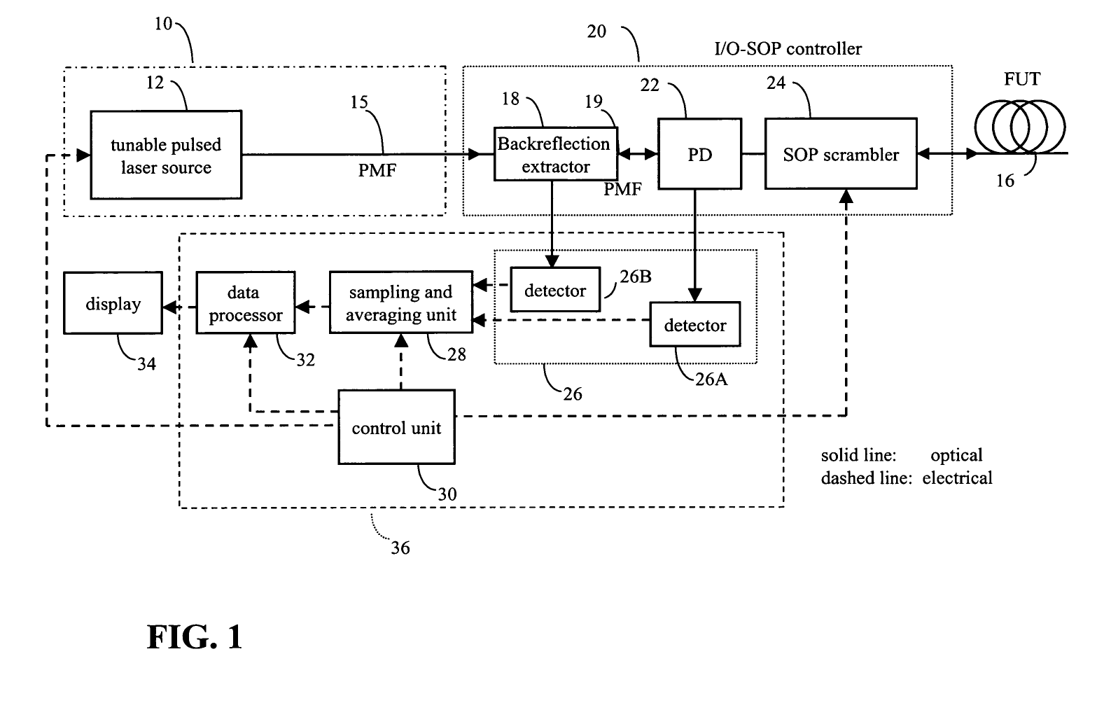

The polarization-sensitive optical time domain reflectometer (POTDR) illustrated in FIG. 1 comprises tunable pulsed light source means 10, bidirectional polarization controller means 20 (conveniently referred to as an I/O SOP controller means), sampling and averaging unit 28 and data processor means 32, all controlled by a control unit 30, and detection means 26 comprising first and second detectors 26A and 26B. The tunable pulsed light source means 10 comprises a tunable laser source 12 whose output is coupled to a polarization maintaining fiber (PMF) 15 for producing light pulses for launching into a fiber-under-test (FUT) 16 via the I/O state of polarization (I/O-SOP) controller means 20, which, as explained later, also receives corresponding backreflected light from the FUT 16.

The I/O SOP controller means 20 comprises a backreflected light extractor, specifically a polarization-maintaining circulator 18 in FIG. 1, a polarization discriminator (PD) means 22, specifically a polarization beam splitter (PBS) in FIG. 1, and a SOP scrambler 24. The circulator 18 is coupled to the input of PBS 22 by a second PMF 19 so that the optical path from the tunable laser source 12 to the PBS 22 is polarization-maintaining. Preferably, a single-mode fiber is used to couple the PBS 22 to the SOP scrambler 24.

The alignment of PMF 15 is fixed in the factory in such a manner that substantially all of the optical power from the tunable pulsed laser source 12 is maintained in one of the two axes of the fiber 15 (conventionally, the “slow” axis). Since the circulator 18 is polarization-maintaining, this alignment is maintained until the distal end of PMF 19, at its point of attachment to PBS 22. During attachment of each end of the PMFs 15 and 19 to the component concerned, the azimuthal orientation of the PMF 15/19 is adjusted to ensure maximum transmission of the optical pulses towards the FUT 16.

Backreflected light caused by Rayleigh scattering and, in some cases, discrete (Fresnel) reflections, from the FUT 16 enters the I/O-SOP controller 20 in the reverse direction. Its SOP is transformed by the SOP scrambler 24, following which the light is decomposed by the PBS 22 into two components having orthogonal SOPs, typically linear SOPs at 0- and 90-degree relative orientations. The first detector 26A is connected to one of the two outputs of the PBS 22 to receive one of these orthogonal components and the circulator 18 is connected to the other output (with respect to backreflected light from the FUT 16). The second detector 26B is in turn connected to that output port of the circulator 18 that transmits light from the PBS 22, so as to receive the other orthogonal component. Once suitably calibrated to take into account the relative detector efficiencies, wavelength dependence, circulator loss, etc., as will be described hereinafter, the sum of the detected powers from detectors 26A and 26B is proportional to the total backreflected power (S₀).

Under the control of control unit 30, which also controls the tunable laser source 12, the sampling and averaging circuitry 28, in known manner, uses an internal analog-to-digital converter to sample the corresponding electrical signals from the detectors 26A and 26B as a function of time to obtain the corresponding electrical impulse response signals, then averages the impulse-response signals corresponding to a particular series of light pulses to produce an OTDR trace for that series. The resulting OTDR traces are used by a data processor 32 to derive the cumulative PMD curve PMD(z), i.e., the polarization mode dispersion (PMD) as a function of the distance z along the FUT 16 from its proximal end, that is the end which is coupled to the I/O-SOP controller 20. It will be appreciated that the usual conversions will be applied to convert time delay to distance according to refractive index.

In addition to controlling the sampling and averaging circuit 28, the control unit 30 controls the wavelength of the tunable pulsed laser source 12 and the I/O-SOP selected by I/O-SOP controller 20. More specifically, for each setting k of the I/O-SOP controller 20, the control unit 30 causes the backreflected power to be measured at least one pair of wavelengths λ_{L}^{(k)} and λ_{U}^{(k)}, respectively, that are closely-spaced relative to each other. The center wavelength of the pair of series of light pulses is defined as the average of the actual wavelengths of the series of light pulses, i.e., λₖ=(λ_{L}^{(k)}+λ_{U}^{(k)})/2. (The labels L and U refer, for convenience and ease of understanding, to “lower” and “upper” with respect to the center wavelength λ^{k}).

It should be appreciated that, where the group comprises more than one pair of series of light pulses, the center wavelength as defined above in fact differs for each pair in the group. It must also be appreciated that the center wavelength is only a conceptual definition, and was defined only for the purpose of facilitating description of the basic one pair implementation. It is not needed anywhere in the computations, and there is no need for accurately “centering” the pair on some target center wavelength since the latter is defined as the mean of the actual pair. Nor is the laser wavelength set at the center wavelength. Only the knowledge of the step is needed, i.e., the difference between any pair that is used in the computations of cumulative PMD, irrespective of the center wavelength, even if it were to be random and unknown.

The I/O-SOP controller 20 sets the different I/O-SOPs in a pseudo-random manner, such that the points conventionally representing SOPs on the Poincaré sphere are uniformly-distributed over the surface of said sphere, whether the distribution is random or a uniform grid of points.

Before the operation of the POTDR is described in more detail, and with a view to facilitating an understanding of such operation, the theoretical basis will be explained, it being noted that such theory is not to be limiting.

### Fundamentals

The computation of the PMD applies the combined equations of the Generalized Interferometric Method (GINTY) and Poincaré Sphere Analysis (PSA), with appropriate adaptations resulting in the equations given below.

It should be recalled that PMD is the statistical RMS value of differential group delay DGD(λ), estimated by averaging over a large wavelength range, or over a period of time, ideally both, so that the largest possible number of random occurrences of DGD are observed to obtain its RMS value.

### Single-End Roundtrip-DGD Measurement Using a Mirror

If a mirror were at distance z along the FUT, and if one could neglect Rayleigh backscattering and any spurious discrete reflections, the OTDR could be replaced by a CW laser (no pulses) and a power meter for measuring the power reflected from the mirror at two closely spaced optical frequencies, ν_{U} and ν_{L}, around a given center frequency, ν, for a large number K of I/O-SOPs, i.e., one such setting referring to both the input-SOP and the analyzer axis “seen” by the backreflected light. (N.B. λ=c/ν, where λ is the vacuum wavelength of the light. Although the use of optical frequency is more “natural” in this theory, in practice, for closely-spaced wavelengths, wavelengths can be used, it being understood that the appropriate conversion factors are applied to the equations presented herein.). It has been found that, on average over a sufficiently large, uniformly distributed number K of said I/O-SOPs, the mean-square difference between normalized powers observed at ν_{U} and ν_{L} is related to the roundtrip-DGD by a simple relationship, valid in all cases for any type of practical FUT regardless of its degree of randomness or its polarization coupling ratio, including the extreme case of a PMF fiber, i.e.,

$${DGD}_{RoundTrip} ( v ) = \frac{1}{π δ v} arc sin ( {α}_{ds} \sqrt{{〈 Δ {{P}_{r} ( v )}^{2} 〉}_{SOP}} ) \\ where {α}_{ds} = \sqrt{\frac{15}{4}} , \qquad ( 1 )$$

< >_{SOP} represents the average over the K I/O-SOPs, δν=(ν_{U}−ν_{L}) is the “step”, ΔPᵣ is the difference between the normalized powers observed at ν_{U} and ν_{L}, respectively, where the normalized powers are:

$${Pr}_{L}^{( k )} = {u}_{o} \frac{{P}_{L}^{( k )}}{{〈 {P}_{L} 〉}_{SOP}} {Pr}_{U}^{( k )} = {u}_{o} \frac{{P}_{U}^{( k )}}{{〈 {P}_{U} 〉}_{SOP}}$$

where the reference mean-value is u₀=⅔, and the average power is defined as,

$${〈 P 〉}_{SOP} = \frac{1}{2 K} {\sum }_{k} ( {P}_{L}^{( k )} + {P}_{U}^{( k )} ) .$$

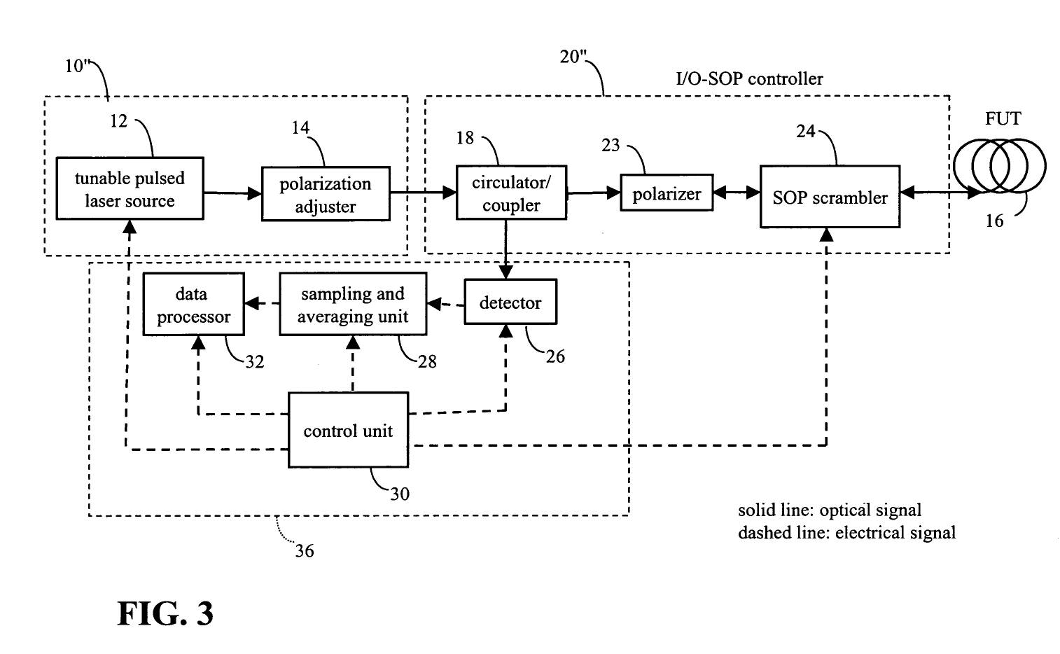

The relationship holds for DGD_{RoundTrip·}δν<½, thus clarifying the meaning of “closely-spaced wavelengths”. The normalized power will in fact be obtained differently in each embodiment, i.e., by suitable programming of the data processor 32. This explanation of the theory is provided for the basic one-photodetector embodiment of FIG. 3, where normalization over the average power is both necessary and sufficient, assuming total power is stable when I/O-SOP is changed, or as a function of time. A detailed description of this normalization procedure is provided hereinafter.

The roundtrip DGD derived by equation (1) is not double the forward DGD. However, when averaged over wavelength, time, or some distance interval Δz, the PMD value (statistical average) is related to the roundtrip-PMD through a simple factor, the roundtrip factor αᵣₜ=\sqrt{⅜}, i.e., PMD=\sqrt{⅜}·PMD_{RoundTrip}, where PMD is defined as the root-mean-square (RMS) value of DGD. It should be noted that a different roundtrip factor results if the alternative definition of PMD, i.e., the mean value of DGD, is used instead of the RMS-DGD definition.

### With OTDR: The Short Pulse Case

OTDR “traces”, or backreflected power as a function of distance z, are the same as if the above measurement were repeated an infinite number of times, with the mirror shifted by a distance increment dz between measurements. Providing that the pulses are very short, and also ignoring the fact that the “coherence noise” always adds to an OTDR trace, the same result as in equation (1) is obtained, except that it is obtained as a function of distance z in one step. The different ΔPᵣ(ν,z) values obtained with different I/O-SOPs are now differences between whole OTDR traces as a function of z, instead of just one number, and give DGD_{RoundTrip} (ν,z).

### The Long Pulse Case

It is generally impractical to use very short pulses in the field, however, because attainment of a useful dynamic range would require an exceedingly long measurement time. Also, reduction of the high level of coherence noise resulting from using short pulses may require an unacceptably large equivalent laser linewidth, which results in a small maximum measurable PMD. The present invention takes account of the finding that, with large pulses, the mean-square differences <ΔPᵣ(ν,z)²>_{SOP} are simply “scaled down” by a factor that can be computed independently from the same raw data. This factor, σᵣ²(z, ν), is the relative variance of the traces, a function of z depending on local characteristics of the fiber, defined as,

$${σ}_{r}^{2} ( z , v ) = {( \frac{1}{{u}_{0} {σ}_{0}} )}^{2} [ {〈 {{P}_{r} ( z , v )}^{2} 〉}_{SOP} - {〈 {P}_{r} ( z , v ) 〉}_{SOP}^{2} ] \qquad ( 2 a )$$

where the reference variance is σ₀²=⅕. The roundtrip DGD then is obtained by dividing the mean-square differences in equation (1) by the relative variance in equation (2a), i.e.

$${DGD}_{RoundTrip} ( z , v ) = \frac{1}{π δ v} arc sin ( {α}_{ds} \sqrt{\frac{{〈 Δ {{P}_{r} ( z , v )}^{2} 〉}_{SOP}}{{σ}_{r}^{2} ( z , v )}} ) \qquad ( 2 b )$$

Furthermore, in preferred embodiments of the invention the averages indicated in equations (2a) and (2b) are preferably carried out over both I/O-SOPs and center-wavelengths, both of which are changed from one group of two closely-spaced wavelengths to the next, thus obtaining the roundtrip PMD instead of only one particular DGD at one particular wavelength. Moreover, since the typical user will prefer the forward PMD value to be displayed instead of the roundtrip value, the result is multiplied by the above-specified roundtrip factor, αᵣₜ=\sqrt{⅜}. The end result is the following fundamental equation:

$$PMD ( z ) = {α}_{rt} \frac{1}{π δ v} arc sin ( {α}_{ds} \sqrt{\frac{{〈 Δ {{P}_{r} ( z , v )}^{2} 〉}_{SOP ; λ}}{{σ}_{r}^{2} ( z )}} ) \qquad ( 3 a )$$

where the average over I/O-SOP in Eq. 2a is also replaced by the average over both I/O-SOP and wavelength, i.e.

$${σ}_{r}^{2} ( z ) = {( \frac{1}{{u}_{0} {σ}_{0}} )}^{2} [ {〈 {{P}_{r} ( z , v )}^{2} 〉}_{SOP ; λ} - {{〈 {P}_{r} ( z , v ) 〉}^{2}}_{SOP ; λ} ] \qquad ( 3 b )$$

As yet another possible, although undesirable alternative, it is also envisaged that, in the above equations (2) and (3), the averages over I/O-SOP and wavelength could be replaced by averages over a large range of optical frequencies (i.e., wavelengths) only, where the I/O-SOP is kept constant. However, in this “constant-SOP” case, the method loses its applicability to all FUT types, i.e., if only the center-wavelength is scanned without I/O-SOP scrambling being applied, these relationships are no longer universally valid, and may be significantly less reliable and/or accurate—even if still roughly valid. Generally, if no I/O-SOP scrambling is performed, the method is only valid if the FUT is “ideal” or “nearly ideal”, i.e., it exhibits excellent random coupling and has an infinite or “near-infinite” polarization coupling ratio, and if one chooses a large value of the PMD·Δν product (typically >10), where Δν is the width of the optical frequency range. As a consequence, small PMD values cannot be measured with any reasonable uncertainty in practice. In addition, one frequently wishes to perform measurement on older installed fibers, which are generally much less “ideal” than fibers produced since about 2001.)

### Method of Operation of the POTDR

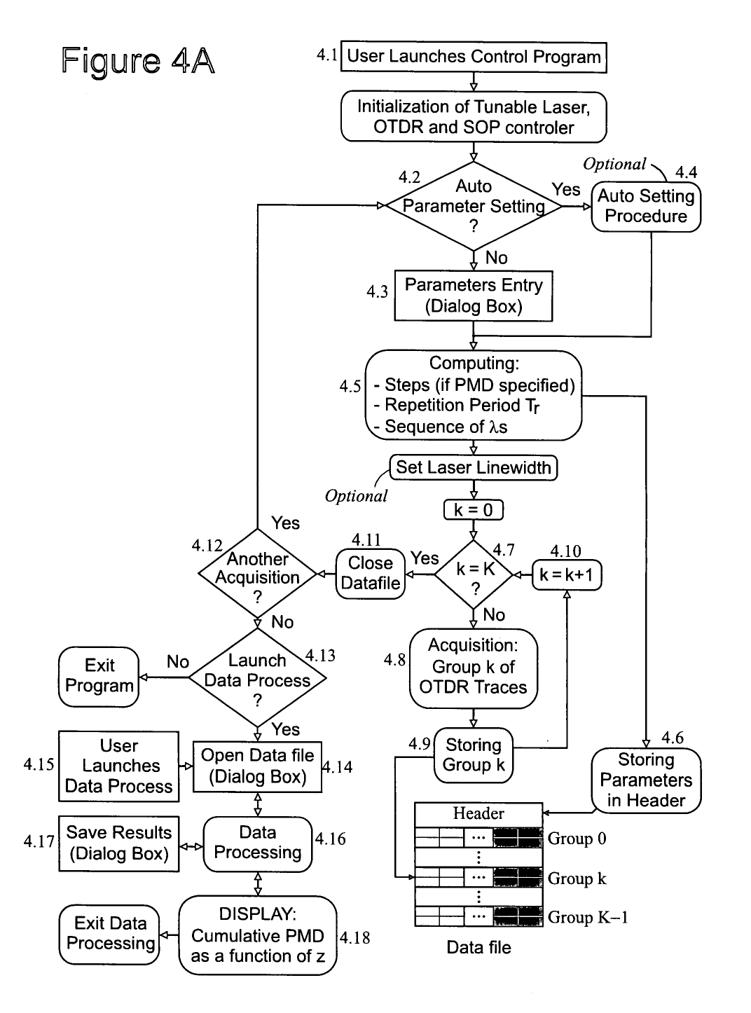

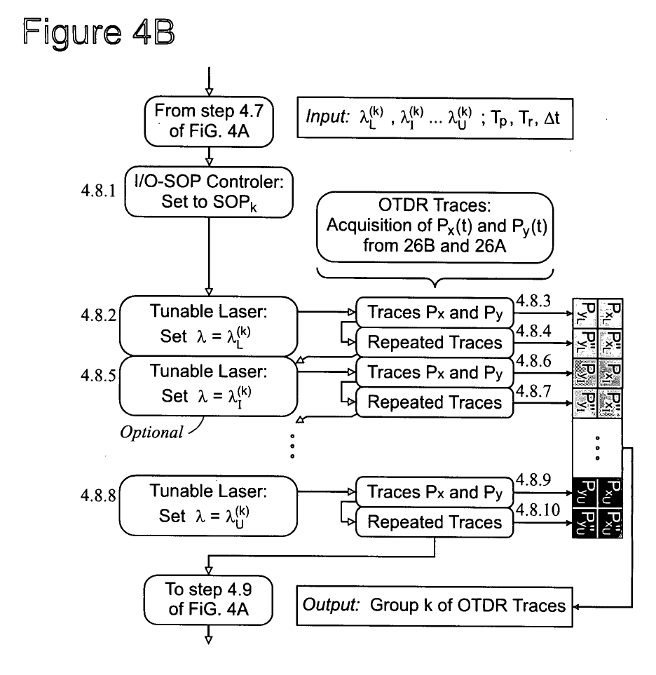

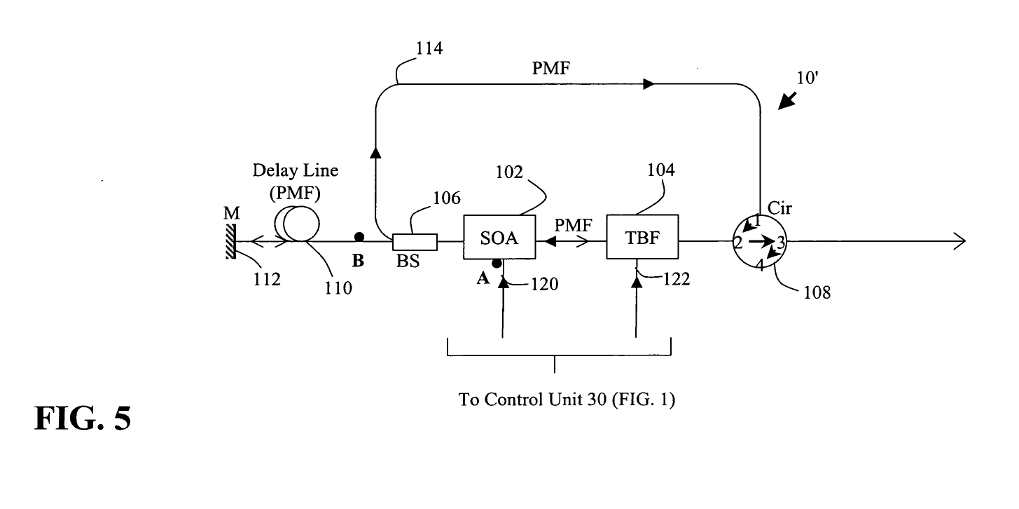

The method of operation of the POTDR illustrated in FIG. 1 will now be described with reference to the flowchart shown in FIGS. 4A and 4B. In step 4.1, the user causes the system to initialize the POTDR, specifically initializing the tunable pulsed light source 10, the I/O-SOP controller 20 and the OTDR detection and processing section 36. Decision step 4.2 prompts the user to select either manual parameter setting or automatic parameter setting. Assuming that the user selects manual parameter setting, the program proceeds to the manual parameter setting step 4.3 and prompts the user as follows:

(a) To set the wavelength range [λmin, λmax] of the group center wavelengths that will be covered by the tunable pulsed laser source 12.
(b) To set the step or difference δν (or δλ) between the pairs of closely-spaced optical frequencies ν_{U} and ν_{L} (or wavelengths). Alternately, the user may enter the anticipated total PMD value of the FUT and leave the processor 32 to select the wavelength step. As an example, the step can be conveniently set as δν=α_{δν}·PMD⁻¹ where α_{δν}˜0.1 to 0.15. It should be noted that the POTDR may be configured to allow the user to select a number M of steps larger than one; the control program will then select M steps based on the anticipated total PMD of the FUT, with appropriate ratios between the steps (note: there is an optimal step for a given PMD value, as large as possible so as to maximize signal-to-noise ratio, but small enough to satisfy the above condition, i.e., PMD·δν<0.1 to 0.15. But the apparatus here described must perform the challenging task of measuring simultaneously a large range of cumulative PMD values as a function of z, from PMD=0, at z=0, to PMD=Total PMD of the FUT, at z=FUT length. This is the reason why a few measurements with different steps in order to measure all different “sections” of the FUT with similar relative (e.g. in %) accuracy is desirable, or alternatively as mentioned here and above, use more than two closely-spaced wavelengths per group, a number N_{λ} of wavelengths per group leading to a theoretical number of M=N_{λ}·(N_{λ}−1)/2 pairs with different steps in each scan, so as to save time).
(c) To set the number (K) of center-wavelengths and/or I/O-SOPs selected by the I/O-SOP controller 20, i.e., the number (K) of groups of traces to be acquired.
(d) To set the averaging time Δt of each individual trace (for example, Δt=1 or 2 seconds), or set the number electrical impulse response signals to be averaged to obtain each individual trace (for example 1250 or 2500).
(e) To set the pulse duration (as Tp=50, 100, 200, 300 ns), or length.
(f) To specify the FUT length, normally the full effective optical length of the FUT.

If, in decision step 4.2, the user selects automatic parameter setting, the program proceeds to step 4.4 and carries out the following steps:
Selects certain default measurement parameters, namely
(1) center wavelength range [λmin, λmax] that will be covered by the tunable pulsed laser source 12, typically the whole wavelength range that the actual tunable laser can access.
(2) number K of I/O-SOPs and/or center wavelengths to be set by the I/O-SOP controller 20, for example, 100 or 200, for final POTDR data acquisition,
(3) averaging time Δt (for example, Δt=1 or 2 seconds) or number of electrical impulse response signals to be averaged (for example 1250 or 2500) for each individual OTDR trace,
(4) pulse duration (e.g., Tp=50, 100, 200, 300 ns) or pulse length, and
(5) linewidth of tunable pulsed laser (optional).
It is noted that these default parameters set in (1), (3), (4) and (5) will also be used for pre-scan acquisition.
The POTDR conducts a pre-scan using a reduced number of groups, such as K=20, to obtain rough estimates of the FUT length and the optimal wavelength step δλ (or frequency difference δν) between the two closely-spaced optical frequencies ν_{U} and ν_{L} (or λ_{U} and λ_{L}). Thus, the OTDR will launch a standard OTDR pulse (e.g. 1 μs) to detect the end of the fiber so that the FUT length can be obtained and the pulse repetition period deduced according to the round-trip time through the length of the fiber. Acquisition of OTDR traces then will be performed to find the best suited step or difference δν (or δλ) between the two closely-spaced optical frequencies ν_{U} and ν_{L} (or λ_{U} and λ_{L}) via a fast estimate of the overall PMD of the FUT. For example, such acquisition may be carried out by using, for each group, four different laser wavelengths (N_{λ}=4) to obtain a total combination of six different wavelength steps (M=6). The best suited wavelength step to be used in the actual POTDR data acquisition may be found by processing of these pre-scan data.

Once the measurement parameters have been entered, whether manually or automatically, the program proceeds to step 4.5 and computes wavelength step δλ (or frequency difference δν) if the anticipated total PMD of the FUT has been specified or estimated via the aforementioned auto-setting procedure, the repetition period Tᵣ according to the round-trip time through the length of the fiber, and the appropriate sequence of wavelengths based on the parameter settings.

Finally, all the measurement parameters, whether directly specified or computed as described above, are stored in the header of the data file (Step 4.6).

FIG. 4A shows an optional step (following step 4.5) for setting the laser linewidth, if allowed by the laser light source 12, according to the previously-entered parameters. For example, a small (large) linewidth may be chosen to measure large (small) total PMD. In the case where the total PMD is not specified and no auto-setting procedure has been carried out, the specified wavelength step (δλ) may be used to estimate the total PMD and then the laser linewidth may also be selected accordingly.

With the group number register initialized to k=0, decision step 4.7 determines whether the total number of groups of traces have been acquired; if not, the program proceeds to step 4.8 to acquire the group k of OTDR traces.

FIG. 4B shows in more detail the trace acquisition step 4.8 to acquire a kth group of OTDR traces. As described previously, there is at least one pre-defined frequency difference δν (or wavelength step δλ) between the two closely-spaced optical frequencies ν_{U} and ν_{L} (or wavelengths), and hence the number of total selected laser wavelengths must be at least two. If a plurality of different wavelength steps δλ are used, then these wavelength steps may be selected to optimally measure different ranges of PMD values. For example, one may select to have two wavelength steps, δλ₁ and δλ₂, which requires N_{λ}=3 different wavelengths per group. Furthermore, a judicious choice of the ratio of said two steps may be, for example, δλ₁/δλ₂=5. The maximum measurable PMD, PMDₘₐₓ corresponding to a given step δν can be estimated as PMDₘₐₓ˜αᵣₜ(πδν)⁻¹, and δλ can be extracted from δλ=(λ₀²/c)·δν, where λ₀=(λₘᵢₙ+λₘₐₓ)/2. The control unit 30 controls the POTDR to obtain the kth group of traces as follows:
Set I/O-SOPₖ by means of the I/O-SOP controller 20 (step 4.8.1 of FIG. 4B).
Control the tunable pulsed laser 12 to set wavelength to λ_{L}^{(k)} (step 4.8.2 of FIG. 4B) and then launch OTDR light pulses. Detection and processing unit 36 acquires OTDR traces Px_{L} and Py_{L} (step 4.8.3 of FIG. 4B). The same data acquisition process is repeated to obtain duplicate or repeated traces Px_{L}″ and Py_{L}″ (step 4.8.4 of FIG. 4B).
Repeat the same data acquisition for the upper wavelength λ_{U}^{(k)} while keeping the same I/O-SOP. The detection and processing unit 36 then acquires OTDR traces Px_{U}, Py_{U} and duplicates Px_{U}″, Py_{U}″ (steps 4.8.9 and 4.8.10 of FIG. 4B).
Where the group comprises more than one pair of series of light pulses, to set the wavelength to at least one additional wavelength λ_{I}^{(k)} intermediate the lower and upper wavelengths (step 4.8.5 of FIG. 4B). The detection and processing unit 36 acquires OTDR traces Px_{I} and Py_{I} (step 4.8.6 of FIG. 4B). The same data acquisition procedure is repeated to obtain the repeated traces Px_{I}″ and Py_{I}″ (step 4.8.7 of FIG. 4B).

Once the kth group of OTDR traces have been acquired as described above, in step 4.9 (see FIG. 4A) the group is saved into the data file. Step 4.10 then increments the group number register.

The data acquisition step 4.8 and group storing step 4.9 will be repeated for different center-wavelengths and/or I/O-SOPs selected by the I/O-SOP controller 20 in accordance with the parameter setting step 4.2 or 4.3 until K groups of traces have been acquired and stored in the data file.

At this stage, the measurement parameters and all groups of OTDR traces have been saved in the same data file.

Also at this stage, decision step 4.7 gives a positive result and, in step 4.11, the program closes the data file. Optional decision step 4.12 then gives the user an opportunity to initiate the acquisition of another K groups of traces for the same FUT. If the user decides to do so, the program returns to the parameter setting step 4.2. If not, decision step 4.13 gives the user the option of exiting, in which case the data stored in the data file will be retained for later processing, or initiating processing of already acquired and stored data.

If processing is initiated, step 4.14 allows the user to select the data file to be processed in a conventional “open file” dialog box, whereupon, in step 4.16, the data processor 32 accesses the pre-saved acquisition data and associated measurement parameters from the data file, and uses the data to compute cumulative PMD as a function of distance (z) along the FUT. On the other hand, box 4.15, which is not a “step” as such, indicates that the user may launch the data processing software independently at any time, even if no acquisition was just completed, to process any previously acquired data file. In step 4.17, the data processor 32 saves the results (e.g. the cumulative PMD curve as a function of z and measurement parameters in a file retrievable by a spreadsheet software) and in step 4.18 displays or otherwise outputs the resulting cumulative PMD curve in a tangible form.

The manner in which the data processing step 4.16 processes the stored data will now be described.

### Data Processing

### 1. The Data Structure

Each OTDR trace, obtained with one given setting of the wavelength and of the I/O-SOP as described in the Method of Operation, constitutes the elementary data cell. One trace consists of N power values corresponding to N values zₙ of the distance z, with n=0 . . . (N−1).

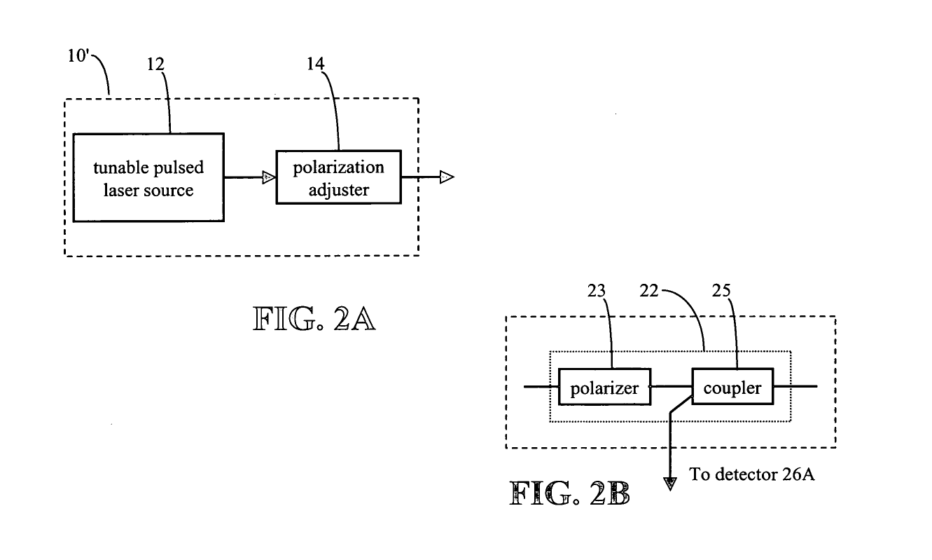

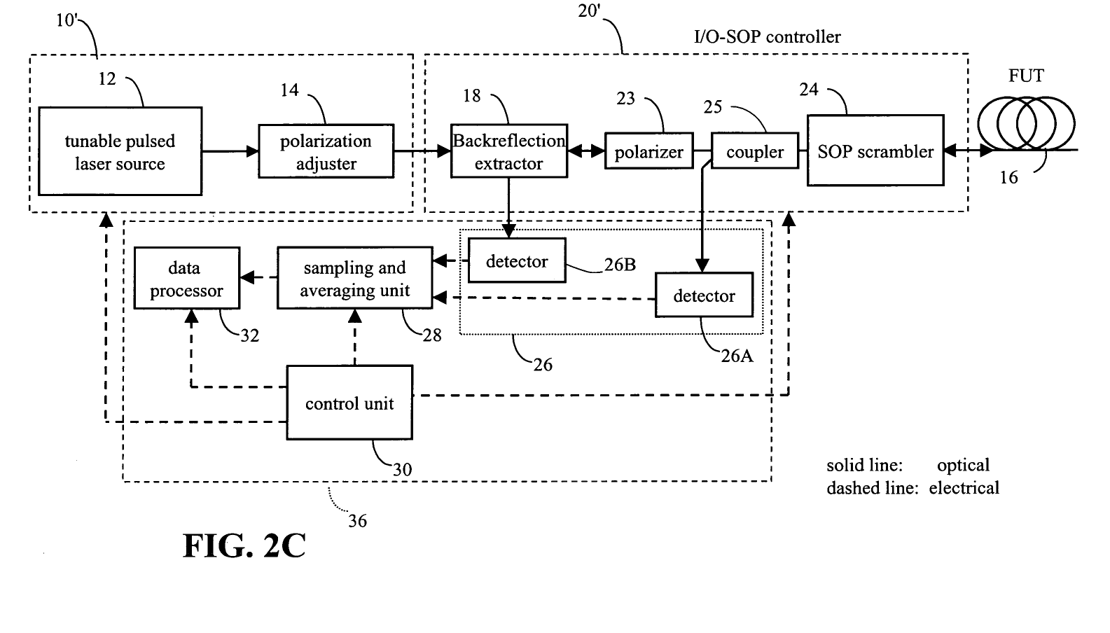

The next larger data unit is one group of four traces, two sets of four traces for the embodiments of FIG. 1 and FIG. 2C where two traces are obtained simultaneously from photodetectors 26A and 26B (or sequentially in the case where an optical switch is used with one detector), all obtained with a given I/O-SOP as set by I/O-SOP controller 20. The two sets of four traces forming group k preferably have been obtained in the following sequence (time flowing from left to right), where the labels x and y refer to the traces obtained simultaneously from photodetectors 26B and 26A, respectively, λ_{U}^{(k)}−λ_{L}^{(k)} is equal to the step δλ, the center wavelength is defined as λₖ=(λ_{U}^{(k)}+λ_{L}^{(k)})/2, and the double prime indicates the repeated traces:

### I/O-SOPₖ and/or λₖ:

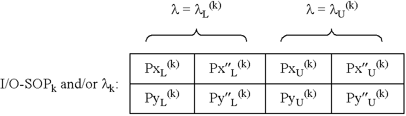

Finally, the overall data stored in the data file after acquisition is depicted as a matrix in Eq. (4) below, to which we will refer in all that follows. The matrix comprises K groups each of four OTDR traces (two sets of four when two photodetectors are used), each trace consisting of N points corresponding to N values of distance zₙ, where n=0 . . . (N−1):

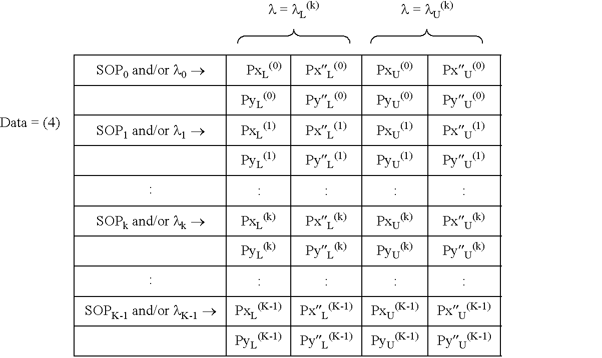

### 2. Auto Calibration of the Relative Gain

For the preferred embodiment of FIG. 1, it is necessary to perform the below described calibration procedure of the relative gain of the two detectors 26A and 26B before proceeding with any further computation. The same procedure is not performed for the other embodiments.

The calibration principle is predicated upon the fact that, when an I/O-SOP scrambler is used to generate a sufficiently large number of SOPs so as to substantially cover the Poincaré Sphere, the average power of the backreflected light over any segment along the FUT 16 will exit from the two ports of the PBS with a 2:1 ratio, the higher power corresponding to the port to which detector 26B is connected and the lower power corresponding to the port to which detector 26A is connected. Hence, any observed deviation from this 2:1 ratio for the observed detector powers can be quantified and taken into account, as follows.

After data acquisition is completed, K groups of four OTDR traces obtained from both photodetectors have been stored, i.e., a total number of J=4·K traces from detector 26A and also J=4·K traces from detector 26B, as depicted in matrix (4). The j^{th} traces (j=0, 1 . . . (J−1)) from 26B and 26A are referred to below as Px(z)ⱼ and Py(z)ⱼ, respectively. If the overall losses in the two arms of the PBS were identical and the gains of both photodetectors and associated electronics were also equal, the ratio of the traces Py and Px after averaging both populations over all J occurrences and over all the N values of z would be

$$\frac{< Px >}{< Py >} ≡ \frac{{\sum }_{j} {\sum }_{n} {Px ( {z}_{n} )}_{j}}{{\sum }_{j} {\sum }_{n} {Py ( {z}_{n} )}_{j}} = 2$$

In practice, the ratio obtained from the average of the measured traces does not equal 2 because of different losses in the arms of the PBS and different “effective” gains of the photodetectors, which includes the photodiode responsivity as well as the overall gains of the following electronics, amplifiers and sampling circuitry. (Note that it is not necessary to determine the individual gains separately.) Therefore, before proceeding with the rest of the computations, all the J traces obtained from photodetector 26A, i.e. all the Py(z)ⱼ, are multiplied as follows:

Py(z)ⱼ≡g·Py(zₙ)ⱼ

where

$$g = \frac{1}{2} \frac{< Px >}{< Py >} = \frac{{\sum }_{j} {\sum }_{n} {Px ( {z}_{n} )}_{j}}{{\sum }_{j} {\sum }_{n} {Py ( {z}_{n} )}_{j}}$$

In practice, for center wavelengths that are relatively closely-spaced (e.g. <20 nm), the relative wavelength dependence of the components, detectors, etc. may be negligible and this calibration process need only be carried out once per POTDR measurement sequence. Otherwise, this calibration may need to be carried out at every center wavelength, thereby increasing the overall measurement time of the measurement sequence.

As a result of the calibration, i.e. after all Py traces have been multiplied by the measured relative gain as described above, the data processor 32 can compute the normalized OTDR traces. More precisely, the normalized traces in the case of the embodiment of FIG. 1 are obtained by dividing either the sampled signal Px from detector 26B, or signal Py from detector 26A, preferably the difference between the sampled signals from detectors 26A and 26B, (Px-Py) or (Py-Px), as will be described in more details in the next section, or any weighted difference (1+w)⁻¹(Px−w·Py), by the sum (Px+Py) of the sampled signals from both of the detectors 26A and 26B which represents the total backreflected power impinging on the PBS, i.e., without selection of a particular polarization component. The preferred computations giving the normalized OTDR traces for all preferred embodiments will now be described in details.

### 3. The Point-by-Point Computation

The OTDR traces are processed to obtain the cumulative PMD as will now be described. It should be noted that the computation of PMDₙ at each point zₙ along the FUT 16 is performed independently of any other point n. Each is deduced from averages over I/O-SOP and/or wavelength only. Thus, in the computations described below it is inappropriate to use the index n; it must simply be understood that the calculation is repeated in the same way for each point n, or, in other words, effectively at each distance zₙ. In all that follows, the symbols refer to the matrix “Data” in Eq. (4). Let's also remind that the labels x and y refer to the traces obtained from photodetectors 26B and 26A, respectively.

### 3.1 The Normalized Traces

The normalized traces, labelled hereinafter as Pr, are computed differently according to the embodiment.

(i) For the embodiment of FIG. 1 (two photodetectors with a PBS), the normalized OTDR trace is computed as follows,

$$P {r}_{L}^{( k )} = \frac{1}{2} \cdot \frac{P {x}_{L}^{( k )} - P {y}_{L}^{( k )}}{P {x}_{L}^{( k )} + P {y}_{L}^{( k )}} {Pr}_{L}^{″ ( k )} = \frac{1}{2} \cdot \frac{{Px}_{L}^{″ ( k )} - {Py}_{L}^{″ ( k )}}{{Px}_{L}^{″ ( k )} + {Py}_{L}^{″ ( k )}} \\ P {r}_{U}^{( k )} = \frac{1}{2} \cdot \frac{P {x}_{U}^{( k )} - P {y}_{U}^{( k )}}{P {x}_{U}^{( k )} + P {y}_{U}^{( k )}} {Pr}_{U}^{″ ( k )} = \frac{1}{2} \cdot \frac{{Px}_{U}^{″ ( k )} - {Py}_{U}^{″ ( k )}}{{Px}_{U}^{″ ( k )} + {Py}_{U}^{″ ( k )}} \qquad ( 5 a )$$

where it should be appreciated that the different Py traces have been pre-multiplied by the measured relative gain, g, as indicated in the description of the auto calibration procedure, before they are used in Eq. (5a).
(ii) For the embodiment of FIG. 2C (two photodetectors with a coupler), the ratio of trace Px over trace Py is first computed as,

$${R}_{L}^{( k )} = \frac{{Px}_{L}^{( k )}}{{Py}_{L}^{( k )}} {R}_{L}^{″ ( k )} = \frac{{Px}_{L}^{″ ( k )}}{{Py}_{L}^{″ ( k )}} \\ {R}_{U}^{( k )} = \frac{{Px}_{U}^{( k )}}{{Py}_{U}^{( k )}} {R}_{U}^{″ ( k )} = \frac{{Px}_{U}^{″ ( k )}}{{Py}_{U}^{″ ( k )}} \qquad ( 5 b )$$

and then the above ratio is normalized with respect to its average over the K groups as,

$${Pr}_{L}^{( k )} = {u}_{o} \frac{{R}_{L}^{( k )}}{{〈 R 〉}_{SOP ; λ}} {Pr}_{L}^{″ ( k )} = {u}_{o} \frac{{R}_{L}^{″ ( k )}}{{〈 R 〉}_{SOP ; λ}} \\ {Pr}_{U}^{( k )} = {u}_{o} \frac{{R}_{U}^{( k )}}{{〈 R 〉}_{SOP ; λ}} {Pr}_{U}^{″ ( k )} = {u}_{o} \frac{{R}_{U}^{″ ( k )}}{{〈 R 〉}_{SOP ; λ}} \qquad ( 5 c )$$

where the reference mean-value is u₀=⅔ and the average ratio R is defined as,

$${〈 R 〉}_{SOP ; λ} = \frac{1}{4 K} {\sum }_{k} ( {R}_{L}^{( k )} + {R}_{L}^{″ ( k )} + {R}_{U}^{( k )} + {R}_{U}^{″ ( k )} ) , \qquad ( 5 d )$$

### Here, the auto calibration procedure is not required, i.e. the above mentioned pre-multiplication of the traces Py by the measured relative gain may be skipped.

(iii) For the embodiment of FIG. 3 (single photodetector), the only available traces are the Px traces (obtained here from photodetector 26). The normalized trace is obtained as in (5c) but without computing the ratio of trace x over trace y first, i.e.

$${Pr}_{L}^{( k )} = {u}_{o} \frac{{Px}_{L}^{( k )}}{{〈 P 〉}_{SOP ; λ}} {Pr}_{L}^{″ ( k )} = {u}_{o} \frac{{Px}_{L}^{″ ( k )}}{{〈 P 〉}_{SOP ; λ}} \\ {Pr}_{U}^{( k )} = {u}_{o} \frac{{Px}_{U}^{( k )}}{{〈 P 〉}_{SOP ; λ}} {Pr}_{U}^{″ ( k )} = {u}_{o} \frac{{Px}_{U}^{″ ( k )}}{{〈 P 〉}_{SOP ; λ}} \qquad ( 5 e )$$

where the average trace is defined as,

$${〈 P 〉}_{SOP ; λ} = \frac{1}{4 K} {\sum }_{k} ( {Px}_{L}^{( k )} + {Px}_{L}^{″ ( k )} + {Px}_{U}^{( k )} + {Px}_{U}^{″ ( k )} ) \qquad ( 5 f )$$

It should be noted that, in the equations above, < >_{SOP;λ} can refer to averaging over either the I/O-SOP or the center wavelength, ideally over both, i.e., changing both I/O-SOP and wavelength from one group of traces to the next. All of these relationships are fundamentally valid in all cases even if only I/O-SOP scrambling is applied, giving the correct value of the DGD at one particular center wavelength. Then, scanning the center wavelength only serves the purpose of averaging DGD over wavelength as per the definition of the statistical PMD value. On the contrary, as discussed earlier, averaging only over wavelength while keeping the I/O-SOP unchanged requires that assumptions about the FUT be met, and also requires a large value of the product PMD·_{Δν}. The same remarks apply for the equations presented hereinafter.

### 3.2 Relative Variance

The relative variance, as in equation (3b), is computed here as the average of the four available estimates, i.e.,

$${σ}_{r}^{′2} = {( \frac{1}{{u}_{0} {σ}_{0}} )}^{2} [ \frac{\begin{matrix}var ( {Pr}_{L} ) + var ( {Pr}_{L}^{″} ) + \\ var ( {Pr}_{U} ) + var ( {Pr}_{U}^{″} )\end{matrix}}{4} ] \qquad ( 6 )$$

where the reference variance is σ₀²=⅕ and the function “var” is defined as,

var(Pr_{L})=[<Pr_{L}²>_{SOP;λ}−<Pr_{L}>_{SOP;λ}²]

and analogous expressions can be written for the three other columns.

### 3.3 Mean-Square Differences

The calculation here differs from the simple mean-square found in Eq. (3a) which, for greater clarity, did not take into account the noise. Instead, the product of the repeated differences between normalized traces at λ_{U} and λ_{L} is averaged as follows,

$$\begin{matrix}{〈 Δ {P}_{r}^{2} 〉}_{SOP ; λ} = 〈 ( {Pr}_{U} - {Pr}_{L} ) \cdot {( {Pr}_{U}^{″} - {Pr}_{L}^{″} 〉}_{SOP ; λ} \\ = \frac{1}{K} {\sum }_{k} ( {Pr}_{U}^{( k )} - {Pr}_{L}^{( k )} ) \cdot ( {Pr}_{U}^{″} - {Pr}_{L}^{″} )\end{matrix} \qquad ( 7 )$$

In conventional mathematical terms, Eq. (7) may be referred to as the second-order joint moment of the repeated differences. Doing so, the noise averages to zero instead of being “rectified”, because the noise superimposed on a given trace is not correlated with the noise superimposed on the corresponding repeated trace. That is the first motivation for sampling repeated traces.

### 3.4 Noise Variance

The second motivation for sampling repeated traces, which are substantially identical in the absence of noise, for each setting of center wavelength λ and SOP, is the ability to obtain an accurate estimate of the noise variance. That is because the relative variance, as computed in Eq. (6), includes both the variance of the hypothetical noiseless trace and the variance of the noise. However, if the noise variance is known, it can be subtracted since the variance of the sum of two independent random variables is equal to the sum of the variances. But thanks to the repeated traces, the noise variance can be estimated independently as follows:

$${σ}_{noise}^{2} = {( \frac{1}{{u}_{0} {σ}_{0}} )}^{2} {〈 ( {Pr}_{L} - {Pr}_{L}^{″} ) ( {Pr}_{U} - {Pr}_{U}^{″} ) 〉}_{SOP ; λ} \qquad ( 8 )$$

The noise variance (Eq. 8) is then subtracted from the first estimate of the relative variance (Eq. 6) in the computation of the final relative variance as follows,

σᵣ²=σ′ᵣ²−σₙₒᵢₛₑ² (9)

### 3.5 Computation of the Cumulative PMD

The cumulative PMD then is computed according to the arcsine formula as,

$$PMD = {α}_{rt} \frac{1}{π δ v} arc sin ( {α}_{ds} \sqrt{\frac{{〈 Δ {P}_{r}^{2} 〉}_{SOP ; λ}}{{σ}_{r}^{2}}} ) \qquad ( 10 )$$

It should be appreciated that the arcsine formula, (10), is not the only possible one. The purpose of using this formula is to obtain a result that is unbiased even if using a relatively large step, such that PMD·δν˜0.15, without introducing a significant error; this in order to maximize the signal-to-noise ratio and therefore the dynamic range of the instrument. If one were not concerned with maximizing the dynamic range, or keeping the overall measurement time reasonable, one might select a much smaller step, and use the simpler differential formula that follows,

$$PMD = {α}_{rt} {α}_{ds} \frac{1}{π δ v} \cdot \sqrt{\frac{{〈 Δ {P}_{r}^{2} 〉}_{SOP ; λ}}{{σ}_{r}^{2}}} \qquad ( 11 )$$

This is not to infer that this formula is better or particularly advantageous, but merely that it may conveniently be used if the step is much smaller, i.e., satisfying the condition PMD·δν<0.01. The cumulative PMD curve as a function of z is obtained by repeating the computation above, from equations (5) to equation (10), at each point n corresponding to distance zₙ.

### 3.6 Optional Application of a Linewidth Correction Factor

If the effective spectral linewidth of the pulsed laser source is large, it may be desirable to perform an additional, although optional, data “post-processing” step to take into account the dependence of the measured cumulative PMD on the linewidth of the laser. Thus, one may multiply the N above-measured cumulative PMD values at zₙ, PMDₙ, by an appropriate linewidth-dependent correction factor. One expression of such a correction factor, suitable when the laser lineshape is approximately Gaussian, is:

$${α}_{{LW}_{n}} = \frac{1}{\sqrt{1 - {( \frac{{PMD}_{n}}{{PMD}_{sat}} )}^{2}}} \qquad ( 12 )$$

where PMDₛₐₜ is the saturation cumulative PMD value, i.e., the limiting value towards which the measured cumulative PMD tends as the actual cumulative PMD grows toward infinity, if no linewidth correction factor is applied. It is given by:

$${PMD}_{sat} = \frac{1}{4 π} \cdot \frac{1}{{σ}_{vL}} \qquad ( 13 )$$

where σ_{νL} is the rms-width of the laser spectrum. (Note: for a Gaussian lineshape, the full-width at half-maximum is related to the rms-width by Δν_{L}=\sqrt{8·ln(2)}σ_{νL}.)

The last, optional, step comprises the computation of the N values of the correction factor according to Equation (12), and then the obtaining of the corrected PMD values, PMD′ₙ, via multiplication of the PMD values measured before correction by the correction factor, i.e.

PMD′ₙ=α_{LW}_{ₙ}·PMDₙ (14)

For example, if no correction factor is applied, Eqs. (12) and (13) indicate that the maximum cumulative PMD value corresponding to a bias of, say, −10%, is PMDₘₐₓ=0.0817Δ_{νL}⁻¹. As a numerical example for this case, a full-width at half-maximum Δ_{νL}=2 GHz gives PMDₛₐₜ˜93.7 ps and PMDₘₐₓ˜40.8 ps. If the measured value happens to be equal to this pre-determined maximum value of 40.8 ps corresponding to a bias of −10%, then the actual PMD is in fact 45.4 ps, i.e., the measured value suffers a bias of −10%, as stated. Such a residual bias level may be acceptable in many field applications.

However, under these same physical circumstances, if the correction factor α_{LW}=1.11 is applied according to Eq. (14), one obtains the actual cumulative PMD′ of 45.4 ps.

In practice, the uncertainty on the correction factor itself will grow if the correction factor becomes very large, i.e., when the directly measured (i.e., uncorrected) cumulative PMD is too close to PMDₛₐₜ, since any small error in the directly-measured PMD value or in the laser linewidth (or uncertainties as to the effective laser lineshape) can make the correction factor very unreliable, as can be appreciated from Equation (12). However, the uncertainty remains small if the maximum allowable value of the correction factor is limited to a predetermined value, which then determines the maximum PMD that can be measured when the correction factor is applied. Doing so, not only is PMDₘₐₓ larger than it would be without the correction, but more importantly, in contrast with the case where no correction is applied, there is no systematic bias when the actual PMD is equal to PMDₘₐₓ, but rather only a small additional, zero-mean uncertainty. Using the previous example, and setting the correction factor to a reasonable maximum value of 1.25, i.e., still close to unity, the maximum value of the actual PMD that can be measured, without bias, is PMDₘₐₓ˜70 ps, compared to 40.8 ps with a bias of −10% if no linewidth correction factor is used.

It is noted that, whenever the product PMD·Δν_{L} is much smaller than unity, the application of such a correction factor in the post-processing serves no purpose since the factor is very nearly equal to unity anyway. The purpose of applying the correction factor is to increase the maximum PMD value that can be measured with no bias given the real linewidth of the laser.

It should be appreciated that Equation (12) applies for the case of a nearly Gaussian-shaped laser spectrum, and is given by way of example. Other formulas or relationships can be computed either analytically or numerically for any particular laser lineshape that deviates substantially from a Gaussian lineshape. The Gaussian lineshape is a special, though practically relevant, case for which the correction factor can be expressed as a simple analytical formula, whereas such simple analytical formulas cannot be found for arbitrary laser lineshapes.

### Tunable OTDR Source

As mentioned hereinbefore, it is desirable to use many center wavelengths λ as well as many I/O-SOPs. Consequently, it is desirable for the tunable OTDR to be tunable over a large range of wavelengths. Suitable tunable OTDRs, that are tunable over a range of several hundred nanometers, are known to those skilled in this art and so are not described in detail herein.

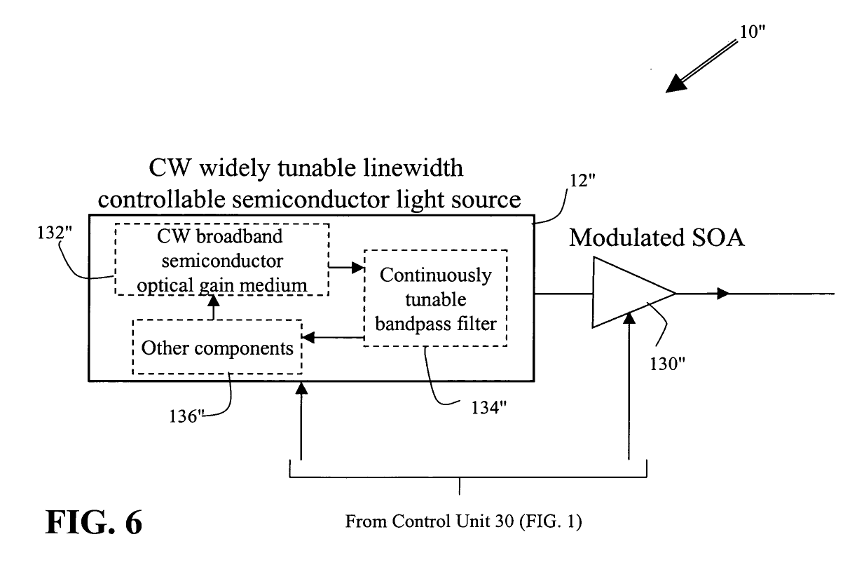

FIG. 5 shows schematically an example of such a tunable pulsed laser source 10′ which is disclosed in commonly-owned United States Provisional patent application Ser. No. 60/831,448 filed Jul. 18, 2006, the contents of which are incorporated herein by reference. The OTDR is based on a ring fiber laser design where a semiconductor optical amplifier (SOA) acts both as (i) a laser gain medium, and (ii) an external modulator that also amplifies the optical pulses when “on”. (The SOA can amplify the input light pulses from 3-6 dBm (input) to 17-20 dBm (output)).

Thus, tunable pulsed laser source 10′ comprises a semiconductor optical amplifier (SOA) 102, a tunable optical bandpass filter (TBF) 104, a beamsplitting coupler 106 and a four-port circulator 108 connected in a ring topology by polarization-maintaining fibers (PMF). The coupler 106 has a first port connected to the SOA 102 by way of the TBF 104, a second port connected via a PMF loop 114 to the circulator 108 and a third port connected to one end of a delay line 110, the opposite end of which is terminated by a reflector 112. Thus, the ring comprises a first, amplification path extending between the circulator 108 and the coupler 106 and containing the SOA 102 and a second, feedback path between coupler 106 and circulator 108 provided by PMF 114.

The coupler 106 extracts a portion, typically 25-50%, of the light in the cavity and launches it into the delay line 110. Following reflection by the reflector 112, the light portion returns to the coupler 106 and re-enters the cavity after a delay Δt equivalent to the round trip propagation time of the delay line 110. Conveniently, the delay line 110 comprises a fiber pigtail of polarization-maintaining fiber and the reflector 112 comprises a mirror with a reflectivity of about 95% at the end of the fiber pigtail. Of course, other suitable known forms of delay line and of reflector could be used.

A control unit 116 is coupled to the SOA 102 and the TBF 104 by lines 120 and 122, respectively, whereby it supplies control signals to selectively turn the SOA 102 on and off, as will be described in more detail later, and to adjust the wavelength of the TBF 104.

Such a tunable pulsed laser source 10′ may provide a high output power at a low cost. For further details of this tunable pulsed laser source 10′ and its operation, the reader is directed to U.S. Provisional patent application No. 60/831,448 for reference.

It should be appreciated that other kinds of tunable pulsed light source could be used instead of that described hereinbefore. For example, a suitable tunable pulsed light source where an acousto-optic modulator is used to pulse the light from a continuous-wave tunable laser is disclosed by Rossaro et al. (J. Select. Topics Quantum Electronics, Vol. 7, pp 475-483 (2001)), specifically in FIG. 3 thereof.

FIG. 6 illustrates schematically another suitable alternative tunable pulsed light source 10″ comprising a continuous wave (CW) widely-tunable linewidth-controllable light source 12″ in combination with an independent SOA 130″ which serves only as an amplifying modulator. The CW light source comprises a broadband semiconductor optical gain medium 132″, typically an optical semiconductor optical amplifier (SOA), and a tunable bandpass filter (TBF) 134″, controlled by the control unit 30 (FIG. 1). The minimum small optical signal gain of >3-5 dB can be close to 200 nm (e.g. from 1250-1440 nm or 1440-1640 nm). This minimum small signal gain is required to compensate the cavity loss so as to achieve a laser oscillation.

The continuously tunable TBF is typically a grating based bandpass filter with a bandwidth of 30 to 80 pm (FWHM), which is used to tune the laser wavelength accurately and also to confine the light (photons) in this small TBF bandwidth so as to give an accurately laser wavelength with a narrow linewidth. The “other components” identified in FIG. 6 by reference number 136″ will include an output coupler (typically 25/75 coupler with 25% the output port, but it can also be 50/50 coupler in order to get more output power) and an optical isolator (which can be integrated into an optical gain medium, such as in the input of SOA).

If a PMF cavity is used, no any additional component is required. But if the cavity is based on SMF-28 fiber, one or two polarization controllers are still required to adjust state-of-polarization (SOP) in the laser cavity.

Use of the SOA 130″ as an external modulator yields several advantages: one is a high light extinction (ON/OFF) ratio of about 50-60 dB, and a second is amplification of the input light to 10-20 dBm with a relative input power (of 0-6 dBm) (note that an output power intensity is dependent on an operation wavelength).

It should also be noted that the device of FIG. 6 will not produce a very narrow linewidth laser. The laser linewidth strongly depends on the TBF bandpass width. Typically, laser linewidth is about 4 to 15 GHz (for TBF bandwidth of 30-80 pm). However, a wide laser linewidth (bandwidth) is advantageous for any OTDR application (including POTDR) for reducing coherence noise on the OTDR traces.

Typically, the tunable pulsed light source of FIG. 6 can be designed to have a wavelength accessible range close to 200 nm (for example, from 1250-1440 nm or 1440-1640 nm) by choosing properly SOAs (such as SOAs centered at 1350 nm and 1530 nm, respectively with a 3-dB gain bandwidth extends >70 nm and the maximum gain >22 dB).

The spectral linewidth of the tunable pulsed laser sources in the various above-described embodiments might range from less than 1 GHz to more than 15 GHz. In practice, it will usually be determined at the lower end by the need to minimize the coherence noise of the Rayleigh backscattering and at the upper end by the ability to measure moderately high PMD values. It may be advantageous for this linewidth to be known, at least approximately, in order to facilitate application of the linewidth correction factor as described hereinbefore. It may also be very advantageous for the laser linewidth to be adjustable in a known controlled manner, at least over some range, so as to circumvent or significantly mitigate the above mentioned limitation regarding maximum measurable PMD. If such ability to adjust the laser linewidth is available, one may select a larger linewidth where a small PMD value is to be measured, and select a smaller linewidth where a large PMD value is to be measured. Optimally, the laser linewidth would always be set as equal to approximately one half of the selected step δν.

A person skilled in this art will be aware of other alternatives to these tunable light sources.

### Various Modifications to the POTDR Means

The invention encompasses various modifications to the embodiment shown in FIG. 1. For example, in the tunable pulsed light source means 10, the PMF 15 may be replaced by a polarization adjuster 14 (see FIG. 2A) connected by non-polarization-maintaining fiber to the tunable pulsed laser source 12 and to the output of the tunable pulsed light source 10, respectively.

If the optical path between the output of tunable pulsed light source means 10 and the input of the polarization discriminator 22 is polarization-maintaining, the polarization-maintaining circulator 18 in FIG. 1 could be replaced by a polarization-maintaining coupler (e.g., a 50/50 coupler). The circulator is preferred, however, because it gives about 3 dB more dynamic range than a 50/50 coupler.

It is also envisaged that the polarization discriminator 22 could be a polarizer and coupler, as shown in FIG. 2B. In that case, the detector 26A would be connected to the coupler 25 to receive backreflected light that is not polarization-dependent.

If the optical path between the output of the tunable pulsed laser source 12 and the input of the polarization discriminator 22 is not polarization maintaining, the backreflection extractor, i.e., coupler or circulator 18 need not be polarization-maintaining.

Although these modifications may be applied separately, the embodiment of the invention illustrated in FIG. 2C includes several such modifications. Specifically, the optical path between the tunable pulsed laser source 12 and the I/O-SOP controller 20′ is not polarization maintaining, i.e., the PMFs 15 and 19 of FIG. 1 are replaced by a polarization state adjuster 14 connected by single-mode optical-fiber (e.g. a non-PMF fiber marketed as SMF-28 by Corning, Inc.)-based components (such as circulator 18 and polarizing splitter 22), to maximize the pulsed laser optical power passing through the I/O-SOP controller 20.

Instead of PBS 22, the polarization discriminator 22 comprises a polarizer 23 and coupler 25 combination, at the expense of approximately 3-dB of dynamic range for the case of a 50/50 coupler. The first detector 26A is connected to one of the arms of the coupler 25 so as to detect a fraction of the backreflected light for processing to deduce the total backreflected power of the pulses.

In the POTDR of FIG. 2C, an analogous procedure to that described above with respect to the embodiment of FIG. 1 could then be carried out, although not required as stated above, to calibrate the relative sensitivities of the two detectors 26A and 26B, including the losses induced by the intervening circulator or coupler, etc.; in which case the second step of the normalized trace computation, i.e. dividing the computed ratios by the average ratio, is not required.

A person of ordinary skill in this art would be able, without undue experimentation, to adapt the calibration procedure described hereinbefore with reference to the POTDR of FIG. 1 for use with the embodiment of FIG. 2C. That said, it should be appreciated that, in the embodiment of FIG. 2C, calibration of the mean relative gain is not required; the measured total power is independent of SOP, and there is no need for an “absolute” calibration to directly measure absolute transmission values; they can be obtained to within an unknown constant factor. The subsequent normalization over the mean traces averaged over SOPs, as described hereinbefore, eliminates the unknown factor.

It is envisaged that the detection means 26 might comprise a single detector and normalized OTDR traces be obtained by computing an average of all of the OTDR traces in first and second groups of OTDR traces, and dividing each of the OTDR traces by the said average OTDR trace, point by point, to obtain first and second groups of normalized OTDR traces, as described in detail hereinbefore.

FIG. 3 illustrates a POTDR suitable for obtaining the PMD using normalized OTDR traces obtained in this way. The POTDR illustrated in FIG. 3 is similar to that illustrated in FIG. 2C but with coupler 25 and detector 26A omitted. The data processor 32 will simply use the different normalization equations given in the Method of Operation provided hereinbefore.

In any of the above-described embodiments, the operation of the I/O-SOP controller 20 is such that, for a given SOP of the light (which can be any SOP on the Poincaré Sphere) received at its input, the SOP of the light leaving its output will be any one of a number of substantially uniformly distributed SOPs on the Poincaré Sphere, whether the distribution is of random or deterministic nature. Typically, the number of I/O-SOPs is about 100-200 for high quality results, but it could be any practical number. It is noted that the distribution of the I/O-SOP need not, and generally will not, be truly random; so “pseudo-random” might be a more appropriate term in the case where a random distribution is indeed used for convenience because it is easier and less expensive to implement than a uniform grid of I/O-SOPs.

Although it is preferred to use two detectors to obtain two orthogonal polarization components simultaneously, it is envisaged that the two detectors in the embodiments of FIGS. 1 and 2C could be replaced by one detector plus one optical switch. The optical switch is used to route the two orthogonal polarization components of the backreflected light to the detector, for example alternately, so that two orthogonal polarization components of the backreflected light can be detected sequentially by the same detector.

A normalized OTDR trace for that series of light pulses would be obtained by dividing at least one of the OTDR traces corresponding to the two detected different polarization components for that series by the sum of the OTDR traces corresponding to the two detected different polarization components for that series. This alternative may be used regardless of whether the I/O-SOP unit uses a PBS or a coupler. However, it should be appreciated that, in this case, two series of light pulses must be launched into the FUT in order to obtain Px and Py, i.e., one series of light pulses now results in only one OTDR trace instead of two. Any modification to the normalization and processing is expected to be minor and within the common general knowledge of a person skilled in this art.

Alternatively, such an arrangement of one detector plus one optical switch could be used to detect one polarization component and the total optical power sequentially by the same detector. As before, the optical switch would route one polarization component and the total optical power to the same detector, and the normalized OTDR trace corresponding to that particular series of light pulses would be obtained by dividing the OTDR trace for that series by the OTDR trace for that series corresponding to total power. It is also worth noting that, while the use of one detector with one optical switch instead of two detectors disadvantageously at least doubles the total acquisition time in comparison with embodiments using two detectors,

It is also envisaged that a rotating polarization discriminator (PD), whether it is a polarizer or a PBS, may be used to sequentially acquire two orthogonal components for example via rotating the polarization discriminator by 90° to switch from detecting Px to detecting Py, or from detecting Py to detecting Px. The detector means 26, whether a single detector or a pair of detectors, and the sampling and averaging circuitry unit 28, may be as used in standard commercial OTDRs that are known to a person skilled in this art.

The control unit 30 may advantageously be a separate computer. However, it is noted that a single computer could perform the functions of the data processor 32 and the control unit 30.

Various other modifications to the above-described embodiments may be made within the scope of the present invention. For instance the tunable pulsed laser source 12 and I/O-SOP controller 20 could be replaced by some other means of providing the different polarization states of the pulses entering the FUT 16 and analyzing the resulting backreflected signal caused by Rayleigh scattering and/or discrete reflections leaving the FUT 16.

Thus, a polarimeter may be used (splitters with four analyzers and photodetectors in parallel), which measures more than one polarization component of the backreflected signal simultaneously, or some other configuration, so that the power that reaches the photodetectors is dependent on the state of polarization (SOP) of the backreflected light.

It should be noted that each group is not limited to one pair of series of light pulses. Indeed, it may be advantageous to use three or more different closely-spaced wavelengths per group of traces obtained with a common SOP, instead of the minimally-required two closely-spaced wavelengths λ_{L} and λ_{U} (each group then comprises 2·N_{λ} OTDR traces instead of four, two sets of 2·N_{λ} traces in the case of the two-photodetector embodiments, where N_{λ} is the number of wavelengths in a group of series of light pulses). For example, in the case where three closely-spaced wavelengths are used, one can choose the series of light pulses at the lowermost and intermediate wavelengths as one pair, and the series of light pulses at the intermediate and uppermost wavelengths as a second pair, such that the wavelength step between the light pulses in one pair is greater than the wavelength step between the light pulses in the other pair, perhaps a few times larger.

Since there are three combinations of wavelength steps corresponding to three wavelengths (i.e., N_{λ}(N_{λ}−1)/2), one can simultaneously obtain the data corresponding to two significantly different wavelength steps within a measurement time that is only 1.5 times greater than the time required to perform a one-step measurement. Thus, proceeding with three wavelengths (or more) per group proves highly advantageous because the cumulative PMD value can increase significantly along the length of the FUT 16 (from zero to the overall PMD of the FUT), and hence the use of two, three, or more different steps allows one to maintain a satisfactory relative precision (e.g. in %) at all positions along the fiber. It will be appreciated that one could also select the light series at the lowermost and uppermost wavelengths as a third pair, with a wavelength step greater than both of the others.

The use of only one step gives one given absolute uncertainty, as for example ±0.1 ps, which represents a small % uncertainty at a distance where the PMD has grown to a value of 10 ps, but is not good in % at short distances where the PMD is, for example, only 0.2 ps. To get a smaller uncertainty for smaller PMD values, a larger step must be selected. Hence the obvious advantage of implementing such an alternate embodiment where more than two wavelengths per group are used. It changes nothing to the setup, nor to the principle of the invention as described above, but saves time in the overall measurement process.

Although the above-described embodiment changes the center wavelength for each SOP, this is not an essential feature of the present invention. While superior performance can be obtained by covering a large wavelength range in order to obtain the best possible average of DGD, as per the definition of PMD, a POTDR embodying the present invention will work with no bias and may provide acceptable measurements of PMD(z), with a constant center-wavelength.

Advantages of embodiments of the present invention include the fact that:

(a) they relax the FUT 16 stability requirement via the pseudo-random-scrambling approach because no deterministic relationships have to be assumed between traces obtained with different SOPs and/or wavelengths. Moreover, this advantageous relaxing of the FUT 16 stability requirement is obtained whether it is actually performed via I/O-SOP scrambling (the preferred method), or, in the case of an “ideal” FUT (as defined previously), by relying only on the “natural” scrambling of the FUT's PSPs (principal states of polarization) which occur randomly and uniformly as a function of wavelength.
(b) they permit the use of long pulses, in contrast to other POTDRs of the second type, leading to;

(i) significantly increased dynamic range,

(ii) reduction of OTDR coherence noise that is superimposed on the traces,

(iii) increased maximum measurable PMD for a given laser spectral linewidth,

(c) they measure cumulative PMD directly, in contrast to previously-known POTDRs of the first type discussed herein, so no assumed specific birefringence model is needed; in particular, they are especially suitable for measuring cumulative PMD of spun fibers; and.
(d) they produce results that are genuinely quantitative.

Consequently, a tunable-wavelength POTDR embodying the present invention may advantageously provide excellent estimates of cumulative PMD along optical fibers. It may yield reliable PMD measurements even if the FUT 16 moves during the measurement. It can not only indicate the presence of high PMD fiber sections, but also provide quantitative cumulative PMD as a function of optical fiber distance. The dynamic range of the POTDR depends upon which technology will be used, as well as OTDR setting parameters such as pulse duration (or length) and acquisition time. It can range from 10 dB to over 20 dB for overall acquisition times ranging from less than 10 minutes to over 30 minutes.

The OTDR optical pulse duration can be chosen among any reasonable values, such as 5 ns, 10 ns, 30 ns, 50 ns, 100 ns, 200 ns, 300 ns, 400 ns, 500 ns, and so on, depending upon how much dynamic range is needed or desired. The POTDR does not require the equivalent pulse length to be shorter than the beat length of the FUT 16. A long pulse can be used without significant degradation of the measurement results and, thereby, a larger dynamic range can be achieved. This result is a consequence of the random scrambling approach which leads notably to a simple equation (3) that is valid for any FUT 16 and any pulse length according to theory, and of the associated signal processing. Embodiments of the invention can measure PMD over a range extending from a few hundredths of picoseconds to over 50 picoseconds and may be used to locate high PMD fiber sections with excellent spatial resolution.

The technique provides high measurement accuracy and may also be used to compute beat length or birefringence as a secondary result, and thus the so-called coupling length or perturbation length of the FUT 16 as yet another result deduced from the knowledge of both PMD and birefringence. Moreover, by using a possible Fresnel backreflection from the distal end of the FUT 16, the overall PMD of an optical fiber link can also be measured, typically with a dynamic range of over 30 dB (round-trip loss=60 dB). Such an arrangement is disclosed in United States Provisional patent application No. . . . (Attorney docket number AP1303USP) . . . filed contemporaneously herewith.

It is envisaged that, in certain circumstances, a tunable-wavelength POTDR with a large tuning range will not be essential, in which case a single center-wavelength POTDR (i.e. using two wavelengths λ_{U} and λ_{L} on either side of, and defining, the center-wavelength) may be used. This could be achieved by using two fixed-wavelength lasers 10, or by tuning one laser but over the relatively small difference between the two closely-spaced wavelengths.

If the center-wavelength is not scanned, the laser may be a simple and inexpensive DFB laser diode, which can be tuned enough over a few nm to give the two closely-spaced wavelengths.

Conversely, it is also envisaged that a tunable wavelength POTDR with a very large tuning range may be used with no I/O-SOP controller 20, despite the fundamental limitations of this approach explained hereinbefore.

### INDUSTRIAL APPLICABILITY

In contrast to known techniques which use short pulses and/or rely upon the FUT 16 being stable over a relatively long period of time, typically several minutes to several tens of minutes, embodiments of the present invention do not require such long term stability. This is because OTDR traces corresponding to different SOPs and/or wavelengths (a few seconds averaging time), are treated as statistically independent (pseudo-randomly scrambled), without assuming any deterministic relationship between them.

Also, the use of relatively long pulses allows a much larger SNR than otherwise achievable for a given averaging time. This is because (i) the optical energy of the backreflected light is proportional to the pulse length; and (ii) the detector bandwidth can be smaller, allowing both the bandwidth and spectral density of the noise to be reduced. Therefore, the effects of longer pulse length on SNR are three-fold and multiplicative.

With long pulses, the maximum measurable PMD value can be larger for the following indirect reason: With short pulses, the “coherence noise” that superimposes over OTDR traces is larger. To reduce it when using short pulses, the “standard” solution is to increase the equivalent laser linewidth (the laser intrinsic linewidth as such, or alternatively, using dithering or other equivalent means). This limits the maximum measurable PMD. Therefore, as a consequence of these different advantages of using long pulses, the POTDR embodying the present invention can measure large values of cumulative PMD, that typically are seen at large values of z, within a reasonable measurement time.

In all OTDR applications, the power of the light backreflected by the FUT 16 decreases as a function of the distance from which local backscattering occurs, because any FUT 16 has a non-zero loss (typically 0.2-0.25 dB/km@λ=1550 nm). The dynamic range of an OTDR can be defined as the maximum loss for which it is still possible to obtain a good measurement within some reasonable noise-induced uncertainty. Initial test results show a dynamic range of ˜15 dB when using 100-ns pulses and 1-s averaging time of single traces, for a noise-induced uncertainty smaller than 10-15%. Tests with a prototype according to FIG. 3 have shown that, with typical fiber loss (0.2-0.25 dB/km), a POTDR embodying this invention may reach up to 70 km with 200-ns pulses and 2-s averaging time. Similar or better performance it anticipated from the embodiments of FIGS. 1 to 2C.

The combination of the above advantages, i.e., significantly relaxed stability requirement, much larger SNR (and hence measurement range) due to the longer pulse lengths, and a realistic maximum measurable PMD (such as 20 to 30 ps), make a POTDR embodying the present invention particularly suitable for “field measurements” of long, installed fibers, possibly even those including an aerial section.

In the POTDR embodiment described hereinbefore, a single physical “polarization controller mean” is used for setting both the input-SOP and the output analyzer axis. Thus, the two are not independent of one another. It should be appreciated, however, that I/O-SOP controller 20 could comprise two different independent devices, one placed so as to act upon only the optical pulses directed towards the FUT 16 and the other placed so as to act upon only the backreflected signal. It should be noted, however, that the equations would then be different, notably, the value of α_{ds} will be different, and the division by the relative variance will no longer compensate the effect of a large pulse length over beat length ratio. A person skilled in this art would be able to adapt the equations without specific instruction herein but relying upon common general knowledge.

### Scrambling

The term “pseudo-random-scrambling” as used herein is to emphasize that no deterministic relationship between one SOP and the next is needed or assumed by the computation. That is not to say, however, that the physical SOP controller 24 must be truly random as such. It may also follow, for example, that the SOPs define a uniform grid of points on the Poincaré-sphere, with equal angles between the Stokes vectors.

### Uniformly-Distributed

A “pseudo-random” SOP means that each of the three components (s1, s2, s3) of the Stokes vector that represents that SOP on the Poincaré sphere is a random variable uniformly distributed between −1 and 1, and that any one of the three components is uncorrelated with the two others (average of the product=0). Nonetheless, whether the SOPs are on a grid or form a random set, the points on the sphere must be uniformly-distributed.

However, if a grid is used instead of a random set, the calculation or processing must not assume a deterministic relationship between one SOP and the next. Otherwise, if the FUT 16 moves, as may occur in real telecommunications links, such deterministic relationships between traces obtained with a deterministic grid will be lost.

In the above-described embodiment the polarization component of each said backreflected signal is the same as the state of polarization of the corresponding series of light pulses, it is possible for them to be different. It will be appreciated that the computations would then need to be adapted, but such adaptation will not be described here because it should be obvious to a person or ordinary skill in this art.

The entire contents of the various patents, patent application and other documents referred to hereinbefore are incorporated herein by reference.

Although embodiments of the invention have been described and illustrated in detail, it is to be clearly understood that the same are by way of illustration and example only and not to be taken by way of the limitation, the scope of the present invention being limited only by the appended claims.

1. A method of measuring cumulative polarization mode dispersion (PMD) along the length of a fiber-under-test (FUT) comprising the steps of:
launching into the FUT at least two groups of series of light pulses, each group comprising at least one pair of series of light pulses, a wavelength of light pulses in one of the series in the pair being closely-spaced from a wavelength of the light pulses in the other series in said at least one pair, said series of light pulses in each group having input-output polarization states and/or center wavelengths that are uncorrelated with respect to those of the series of light pulses in the at least one other group,
measuring, point-by-point temporally and for each of said at least two groups, differences between respective optical powers of at least one polarization component of light backreflected for at least some of the pairs of series of light pulses,
computing the cumulative PMD as a function of distance z along the FUT as a predetermined function of the measured optical power differences, and
outputting at least a subset of the computed cumulative PMD value, for example as a signal to control a display device or in some other concrete and tangible form.

2. A method according to claim 1, wherein the step of computing the cumulative PMD comprises the steps of:
for each group, computing a pair of normalized OTDR traces corresponding to the pair of series of light pulses, respectively, in that group, point-by-point temporally,
for each temporal point, computing the difference between the normalized OTDR traces in each said pair of normalized OTDR traces;
for each temporal point, computing a mean-square value of the differences corresponding to the pairs of series that are in the different groups but have the same close wavelength spacing;
converting the resulting mean square values to equivalent mean square values with respect to distance z along the FUT,
the cumulative PMD as a function of distance z being computed as a predetermined function of said equivalent mean square values.

3. A method according to claim 1, wherein each group comprises at least one additional series of light pulses having a different wavelength closely-spaced from the first and second wavelengths for that group, the spacings between respective pairs of the three wavelengths being different, OTDR traces are acquired for the at least one additional series of light pulses, and the said differences between normalized OTDR traces are computed also for at least a second pair of said OTDR traces in each group, the resulting additional differences are used to compute a mean-square value of the differences computed for the pairs of additional series that are in the different groups but have the same close wavelength spacing, the resulting additional mean square values are converted to equivalent mean square values with respect to distance along the FUT; a corresponding additional cumulative PMD value at any distance z is computed therefrom, and at least a subset of the additional cumulative PMD is outputted.

4. A method according to claim 1, wherein each group comprises an additional pair of at least two series of light pulses each having the same wavelength as a respective one of the series in the first pair, the differences between optical power of at least one polarization component of light backreflected for at least two groups of the additional pair of series of light pulses being measured in a similar manner to that for the corresponding first-mentioned pair of series of light pulses, the computation of said mean square value for each temporal point taking into account the additional optical power differences.

5. A method according to claim 4, wherein the computing step comprises the steps of computing the relative variance of the normalized traces, point by point temporally, and averaging said relative variances to obtain the overall variance of all of the traces in the at least two groups for each temporal point, and computing the ratio of the mean-square difference over the relative variance, said cumulative PMD at any distance z being computed as a function of said ratio.

6. A method according to claim 5, wherein the cumulative PMD is derived according to the equation:
$$PMD ( z ) = {α}_{rt} \frac{1}{π δ v} arc sin ( {α}_{ds} \sqrt{\frac{{〈 Δ {{P}_{r} ( z , v )}^{2} 〉}_{SOP ; λ}}{{σ}_{r}^{2} ( z )}} )$$
where
relative variance
$${σ}_{r}^{2} ( z ) = {( \frac{1}{{u}_{0} {σ}_{0}} )}^{2} [ {〈 {{P}_{r} ( z , v )}^{2} 〉}_{SOP ; λ} - {〈 {P}_{r} ( z , v ) 〉}_{SOP ; λ}^{2} ]$$
constant
$${α}_{ds} = \sqrt{\frac{15}{4}} ,$$
roundtrip factor αᵣₜ=\sqrt{⅜}, < >_{SOP} is the average over the K SOPs, δν=(ν_{U}−ν_{L}) is the difference between closely-spaced wavelengths expressed as optical frequencies, ΔPᵣ is the difference between the normalized powers observed at ν_{U} and ν_{L}, respectively, where the normalized traces are:
$${Pr}_{L}^{( k )} = {u}_{o} \frac{{P}_{L}^{( k )}}{{〈 {P}_{L} 〉}_{SOP}} {Pr}_{U}^{( k )} = {u}_{o} \frac{{P}_{U}^{( k )}}{{〈 {P}_{U} 〉}_{SOP}}$$
and where reference mean-value is u₀=⅔, and the average power over SOPs is defined as,
$${〈 P 〉}_{SOP} = \frac{1}{2 K} {\sum }_{k} ( {P}_{L}^{( k )} + {P}_{U}^{( k )} )$$

7. A method according to claim 1, wherein each of said at least two groups of pairs of series of light pulses comprises at least ten groups, the series of light pulses in each group having either or both of a different center wavelength and a different SOP as compared with those of the series of light pulses in the at least one other group.

8. A method according to claim 3, wherein the outputted cumulative PMD value as a function of z comprises a subset of values calculated from the first-mentioned cumulative PMD value and a subset from the additional cumulative PMD value, which of the at least two subsets outputted for a given z value being determined according to which close wavelength spacing is the best suited given the knowledge of both the first-mentioned PMD value and additional PMD value at each point z.

9. A method according to claim 1, wherein the step of computing the cumulative PMD value from the optical power differences includes the step of obtaining a normalized OTDR trace for each series of light pulses of a pair by dividing the OTDR trace representing optical power of the backreflected light for that series by the average of at least some, and preferably all, of the corresponding OTDR traces of the series in the different groups.

10. A method according to claim 1, wherein two orthogonal polarization components of the backreflected light are detected for each series of light pulses and a normalized OTDR trace for that series of light pulses obtained by dividing at least one of the OTDR traces corresponding to the two detected different polarization components for that series by the sum of the OTDR traces corresponding to the two detected different polarization components for that series.

11. A method according to claim 10, wherein the two orthogonal polarization components are detected simultaneously.

12. A method according to claim 1, wherein two orthogonal polarization components of the backreflected light are detected for each series of light pulses and a normalized OTDR trace for that series of light pulses obtained by dividing a weighted difference of the OTDR traces corresponding to the two detected different polarization components for that series by the sum of the OTDR traces corresponding to the two detected different polarization components for that series.

13. A method according to claim 12, wherein the two orthogonal polarization components are detected simultaneously.

14. A method according to claim 1, wherein one polarization component and the total optical power are detected, and the normalized OTDR trace corresponding to that particular series of light pulses obtained by dividing the OTDR trace for that series by the OTDR trace for that series corresponding to the detected total optical power.

15. A method according to claim 7, wherein the input-output SOPs of the series of light pulses in the different groups are selected so that the points that conventionally represent these SOPs on the surface of the Poincaré sphere are substantially uniformly-distributed over the surface of the sphere, the distribution being random or a regular grid of points that substantially covers the said surface.

16. A method according to claim 5, wherein each light pulse has a relatively long duration, preferably that is equal to or longer than the minimum beat-length of the FUT.

17. Apparatus for measuring cumulative polarization mode dispersion (PMD) along the length of a fiber-under-test (FUT) comprising:
means for launching into the FUT at least two groups of series of light pulses, each group comprising at least one pair of series of light pulses, a wavelength of light pulses in one of the series in the pair being closely-spaced from a wavelength of the light pulses in the other series in said at least one pair, said series of light pulses in each group having input-output polarization states and/or center wavelengths that are uncorrelated with respect to those of the series of light pulses in the at least one other group,
means for detecting backreflected light from the FUT and measuring, point-by-point temporally and for each of said at least two groups, differences between respective optical powers of at least one polarization component of light backreflected for at least some of the pairs of series of light pulses,
means for computing the cumulative PMD as a function of distance z along the FUT as a predetermined function of the measured optical power differences, and
means for outputting at least a subset of the computed cumulative PMD value, for example as a signal to control a display device or in some other concrete and tangible form.

18. Apparatus according to claim 17, wherein the computing means computes the cumulative PMD by:
for each group, computing a pair of normalized OTDR traces corresponding to the pair of series of light pulses, respectively, in that group, point-by-point temporally,
for each temporal point, computing the difference between the normalized OTDR traces in each said pair of normalized OTDR traces;
for each temporal point, computing a mean-square value of the differences corresponding to the pairs of series that are in the different groups but have the same close wavelength spacing; and
converting the resulting mean square values to equivalent mean square values with respect to distance z along the FUT,
then cumulative PMD as a function of distance z being computed as a predetermined function of said equivalent mean square values.

19. Apparatus according to claim 17, wherein each group launched by the launching means comprises at least one additional series of light pulses having a different wavelength closely-spaced from the first and second wavelengths for that group, the spacings between respective pairs of the three wavelengths being different, the detecting and measuring means acquires OTDR traces for the at least one additional series of light pulses, and the computing means computes said differences between normalized OTDR traces also for at least a second pair of said OTDR traces in each group, and the computing means computes a mean-square value of the differences computed for the pairs of additional series that are in the different groups but have the same close wavelength spacing, converts the resulting additional mean square values to equivalent mean square values with respect to distance along the FUT; and computes a corresponding additional cumulative PMD value at any distance z therefrom, and the output means outputs at least a subset of the additional cumulative PMD.

20. Apparatus according to claim 17, wherein the launching means launches in each group an additional pair of at least two series of light pulses each having the same wavelength as a respective one of the series in the first pair, the detecting and measuring means detects differences between optical power of at least one polarization component of light backreflected for at least two groups of the additional pair of series of light pulses in a similar manner to that for the corresponding first-mentioned pair of series of light pulses, and the computing means computes said mean square value for each temporal point taking into account the additional optical power differences.

21. Apparatus according to claim 20, wherein the computing means computes the relative variance of the normalized traces, point by point temporally, averages said relative variances to obtain the overall variance of all of the traces in the at least two groups for each temporal point, computes the ratio of the mean-square difference over the relative variance, and computes said cumulative PMD at any distance z as a function of said ratio.

22. Apparatus according to claim 21, wherein the computing means computes the cumulative PMD according to the equation:
$$PMD ( z ) = {α}_{rt} \frac{1}{π δ v} arc sin ( {α}_{ds} \sqrt{\frac{{〈 Δ {{P}_{r} ( z , v )}^{2} 〉}_{SOP ; λ}}{{σ}_{r}^{2} ( z )}} )$$
where
relative variance
$${σ}_{r}^{2} ( z ) = {( \frac{1}{{u}_{0} {σ}_{0}} )}^{2} [ {〈 {{P}_{r} ( z , v )}^{2} 〉}_{SOP ; λ} - {〈 {P}_{r} ( z , v ) 〉}_{SOP ; λ}^{2} ]$$
constant
$${α}_{ds} = \sqrt{\frac{15}{4}} ,$$
roundtrip factor αᵣₜ=\sqrt{⅜}, < >_{SOP} is the average over the K SOPs, δν=(ν_{U}−ν_{L}) is the difference between closely-spaced wavelengths expressed as optical frequencies, ΔPᵣ is the difference between the normalized powers observed at ν_{U} and ν_{L}, respectively, where the normalized traces are:
$${Pr}_{L}^{( k )} = {u}_{o} \frac{{P}_{L}^{( k )}}{{〈 {P}_{L} 〉}_{SOP}} {Pr}_{U}^{( k )} = {u}_{o} \frac{{P}_{U}^{( k )}}{{〈 {P}_{U} 〉}_{SOP}}$$
and where reference mean-value is u₀=⅔, and the average power over SOPs is defined as,
$${〈 P 〉}_{SOP} = \frac{1}{2 K} {\sum }_{k} ( {P}_{L}^{( k )} + {P}_{U}^{( k )} ) .$$

23. Apparatus according to claim 17, wherein the launching means launches into the FUT at least ten of said groups each of said at least two groups of pairs of series of light pulses, the series of light pulses in each group having either or both of a different center wavelength and a different SOP as compared with those of the series of light pulses in the at least one other group.

24. Apparatus according to claim 19, wherein the output means outputs the cumulative PMD value as a function of z as a subset of values calculated from the first-mentioned cumulative PMD value and a subset from the additional cumulative PMD value, which of the at least two subsets outputted for a given z value being determined according to which close wavelength spacing is the best suited given the knowledge of both the first-mentioned PMD value and additional PMD value at each point z.

25. Apparatus according to claim 17, wherein the detecting and measuring means detects one polarization component and the computing means obtains a normalized OTDR trace for each series of light pulses of a pair by dividing the OTDR trace representing optical power of the backreflected light for that series by the average of at least some, and preferably all, of the corresponding OTDR traces of the series in the different groups.

26. Apparatus according to claim 17, wherein the detecting and measuring means detect two orthogonal polarization components of the backreflected light for each series of light pulses and the computing means computes a normalized OTDR trace for that series of light pulses by dividing at least one of the OTDR traces corresponding to the two detected different polarization components for that series by the sum of the OTDR traces corresponding to the two detected different polarization components for that series.

27. Apparatus according to claim 26, wherein the detecting and measuring means detects the two orthogonal polarization components simultaneously.

28. Apparatus according to claim 17, wherein the detecting and measuring means detects two orthogonal polarization components of the backreflected light for each series of light pulses and the computing means computes a normalized OTDR trace for that series of light pulses obtained by dividing a weighted difference of the OTDR traces corresponding to the two detected different polarization components for that series by the sum of the OTDR traces corresponding to the two detected different polarization components for that series.

29. Apparatus according to claim 28, wherein the detecting and measuring means detects the two orthogonal polarization components simultaneously.

30. Apparatus according to claim 17, wherein the detecting and measuring means detects one polarization component and the total optical power, and the computing means computes the normalized OTDR trace corresponding to that particular series of light pulses by dividing the OTDR trace for that series by the OTDR trace for that series corresponding to the detected total optical power.

31. Apparatus according to claim 24, wherein the launching means sets the input-output SOPs of the series of light pulses in the different groups so that the points that conventionally represent these SOPs on the surface of the Poincaré sphere are substantially uniformly-distributed over the surface of the sphere, the distribution being random or a regular grid of points that substantially covers the said surface.

32. Apparatus according to claim 22, wherein each of the light pulses has a relatively long duration, preferably that is equal to or longer than the minimum beat-length of the FUT.

33. Apparatus according to claim 17, comprising:
(i) means for injecting into an end of a fiber-under-test (FUT 16) groups of series of light pulses at selected wavelengths and selected input-output states of polarization (I/O-SOPs),
(ii) detection means for detecting, for each of at least some of the light pulses in each series of light pulses, at least one polarization component of the resulting backreflected signal and determining total backreflected power (S₀) of the resulting backreflected signal to provide a corresponding impulse response,
(iii) control means for controlling the injecting means and the detecting, sampling and averaging means to cause:
(a) said injecting means to inject into one end of the FUT a first group of at least a pair of series of light pulses, the light pulses in one series of the pair having a wavelength (λ_{L}⁽⁰⁾) that is closely-spaced from the wavelength (λ_{U}⁽⁰⁾) of light pulses in the other series of said pair, the at least one pair of series of light pulses in said group having the same input-output state of polarization (I/O-SOP₀);
(b) the detecting, sampling and averaging means to detect, for each of at least some of the light pulses in each series of light pulses, at least one polarization component of the resulting backreflected light to provide a corresponding impulse response, said at least one polarization component being the same for each of the light pulses whose polarization component has been detected, and convert each of the impulse responses into a corresponding electrical impulse-response signal to provide a corresponding first group of electrical impulse-response signals, and to sample and average each series of said electrical impulse-response signals to provide a first group of OTDR traces each representing detected backreflected power versus time for a respective one of the series of light pulses of said first group;
(d) said injecting means to inject into said one end of the FUT at least a second group of at least a pair of series of light pulses having either or both of a different input-output state of polarization (I/O-SOP₁) and a different center wavelength (λ₁) as compared with center wavelength (λ₀) of the first group of series of light pulses,
(e) the detecting, sampling and averaging means to detect, for each of at least some of the light pulses in each series of light pulses, at least one polarization component of the resulting backreflected light to provide a corresponding impulse response, said at least one polarization component being the same for each of the light pulses whose polarization component has been detected, and convert each of the impulse responses into a corresponding electrical impulse-response signal to provide a corresponding second group of electrical impulse-response signals, and to sample and average each series of said second group of electrical impulse-response signals to provide a second group of OTDR traces each representing detected backreflected power versus time for a respective one of the series of light pulses of said second group;
(iv) computing means (32) for computing, for each group:
(a) a normalized OTDR trace for each of said OTDR traces;
(b) the difference, point-by-point temporally, between the or each pair of normalized OTDR traces corresponding to said at least one pair of series of light pulses; and
(c) the mean-square value of said differences for each temporal point to obtain a mean square value as a function of time and, using a known effective refractive index of the fiber at or near the measurement wavelengths, the said mean square difference as a function of distance (z) along the FUT;
(c) the PMD value as a predetermined function of said mean-square value as a function of distance, said predetermined function being cast as, for example, a differential formula, an arcsine formula, and so on; and
(vii) outputting the cumulative PMD value as a function of distance z, for example by displaying the graph of cumulative PMD as a function of distance z on a display device.
